(19) United States
(12) Patent Application Publication
(10) Pub. No.: US 2025/0231962 A1
(43) Pub. Date: Jul. 17, 2025

(54) SYSTEMS AND METHODS FOR DATA MANAGEMENT

(71) Applicant: Blockchains, Inc., Reno, NV (US)

(72) Inventors: Alex Oberhauser, Medford, MA (US); Ling Cheung Hughes, Cambridge, MA (US); Eugene Kadish, Cambridge, MA (US)

(73) Assignee: Blockchains, Inc., Reno, NV (US)

(21) Appl. No.: 18/902,277

(22) Filed: Sep. 30, 2024

Related U.S. Application Data
(63) Continuation of application No. 17/312,357, filed on Jun. 9, 2021, now abandoned.
(60) Provisional application No. 62/828,677, filed on Apr. 3, 2019.
(60) Provisional application No. 62/777,675, filed on Dec. 10, 2018.

(51) Int. Cl. G06F 16/27; G06F 16/25; H04L 9/00; H04L 9/32

(52) U.S. Cl. CPC G06F 16/27; G06F 16/256; H04L 9/3218; H04L 9/3239; H04L 9/50

(57) ABSTRACT

Systems and methods for data management. In some embodiments, information may be accessed from a knowledge structure associated with an entity. The knowledge structure may store both private information of the entity and state information of a distributed ledger. For instance, the knowledge structure may include an identity structure for the entity and/or an attribute structure corresponding to an attribute of the entity. The identity structure may store a pointer to the attribute structure. Additionally, or alternatively, the attribute structure may associate a value with the attribute of the entity.

### RELATED APPLICATIONS

This application claims priority benefit under 35 U.S.C. § 119 (e) to U.S. Provisional Application Ser. No. 62/777,675, filed on Dec. 10, 2018, entitled “SYSTEMS AND METHODS FOR DATA MANAGEMENT,” bearing Attorney Docket No. C1494.70004US00, which is hereby incorporated by reference in its entirety.

This application further claims priority benefit under 35 U.S.C. § 119 (e) to U.S. Provisional Application Ser. No. 62/828,677, filed on Apr. 3, 2018, entitled “SYSTEMS AND METHODS FOR DATA MANAGEMENT,” bearing Attorney Docket No. C1494.70004US01, which is hereby incorporated by reference in its entirety.

### BACKGROUND

Individuals, as well as organizations of all types (e.g., government agencies, healthcare institutions, financial institutions, retailers, social networking service providers, manufacturers, etc.), face challenges with respect to data management. For instance, a user holding a collection of data may wish to share some, but not all, of the data with a data recipient such as a doctor, a bank, a retail website, etc. The user may wish to maintain a record indicating what data is shared, when, and with whom. The data, once shared, may be replicated in two separate silos. When the user updates a piece of data, the recipient's copy of the data may become out of date.

### SUMMARY

In accordance with some embodiments, a method is provided, comprising: accessing information from a knowledge structure associated with an entity, wherein the knowledge structure stores both private information of the entity and state information of a distributed ledger.

In accordance with some embodiments, a method is provided, comprising: accessing information from a knowledge structure associated with an entity, wherein the knowledge structure comprises an identity structure for the entity, the knowledge structure further comprises an attribute structure corresponding to an attribute of the entity, the identity structure stores a pointer to the attribute structure, and the attribute structure associates a value with the attribute of the entity.

In accordance with some embodiments, a method is provided, comprising: accessing information from a knowledge structure associated with an entity, wherein the knowledge structure comprises an identity structure for the entity, the knowledge structure further comprises a badge structure, the identity structure stores a pointer to the badge structure, the badge structure stores a pointer to a badge version structure, the badge version structure stores a pointer to an attestation structure, and the attestation structure comprises a cryptographic proof generated based on the badge version structure.

In accordance with some embodiments, a method is provided, comprising: receiving a proposed transaction for a distributed ledger, the proposed transaction comprises a change in a state of the distributed ledger; determining whether to accept the transaction, at least in part by determining whether an entity that has signed the proposed transaction is authorized to make the change in the state of the distributed ledger; and in response to determining that the transaction is to be accepted, generating a query for updating a knowledge structure to reflect the change in the state of the distributed ledger.

In accordance with some embodiments, a system is provided, comprising at least one computer processor and at least one computer-readable storage medium having stored thereon instructions which, when executed, program the at least one computer processor to perform any of the methods described herein.

In accordance with some embodiments, at least one computer-readable storage medium is provided, having stored thereon instructions which, when executed, program at least one processor to perform any of the methods described herein.

### BRIEF DESCRIPTION OF DRAWINGS

FIG. 1A shows an illustrative data management system 100, in accordance with some embodiments.

FIG. 1B shows illustrative data management services 110A-B and illustrative distributed ledger clients 115A-B, in accordance with some embodiments.

FIG. 2A shows an illustrative knowledge graph 200, in accordance with some embodiments.

FIGS. 2B-C show the illustrative distributed ledger clients 115A-B in the example of FIG. 1B, in accordance with some embodiments.

FIG. 3 shows various features of the illustrative data management system 100 in the example of FIG. 1A, in accordance with some embodiments.

FIG. 4 shows an illustrative badge version 400, in accordance with some embodiments.

FIG. 5A shows an illustrative query 500, in accordance with some embodiments.

FIG. 5B shows the illustrative query 500 in the example of FIG. 5A, where the query 500 is re-run in response to an update to an attribute, in accordance with some embodiments.

FIG. 5C shows an illustrative query 550, in accordance with some embodiments.

FIG. 6 shows an illustrative query 600, in accordance with some embodiments.

FIG. 7A-D show, respectively, illustrative relationship charts 700A-D, in accordance with some embodiments.

FIG. 8 shows an illustrative process 800 for a state change, in accordance with some embodiments.

FIG. 9 shows an illustrative relationship chart 900, in accordance with some embodiments.

FIG. 10 shows, schematically, an illustrative computer 1000 on which any aspect of the present disclosure may be implemented.

### DETAILED DESCRIPTION

Aspects of the present disclosure relate to systems and methods for data management. For instance, in some embodiments, techniques are provided for sharing data among different entities (e.g., users, organizations, identifiable objects, physical spaces, etc.) in an efficient and secure manner.

Distributed ledgers have been used to provide tamper-resistant records of transactions (e.g., cryptocurrency transfers, attribute attestations, etc.). Such a ledger may include a data structure that is replicated across a network of nodes. The network nodes may carry out a suitable consensus protocol to ensure that the different replicas of the data structure are consistent with each other. The consensus protocol may be chosen such that an attacker may modify the data structure only by gaining control of at least a threshold percentage of computational power within the network (e.g., a majority of the network nodes).

Despite having a built-in mechanism for data synchronization, distributed ledgers may be less suitable for data sharing applications. For instance, distributed ledgers may achieve trust by sharing a global state among multiple network nodes. The network nodes may be operated by different entities, for example, to make it more challenging for an attacker to compromise a large percentage of the network nodes. If sensitive data is stored directly on a distributed ledger, such data may be visible to all network nodes maintaining the distributed ledger, which may be undesirable. Therefore, in some embodiments, a cryptographic hash of sensitive data, instead of the sensitive data itself, may be stored on a distributed ledger. For instance, when a source entity shares a value of an attribute with a recipient entity, a cryptographic hash of the attribute value may be stored on the distributed ledger. At a later time, the cryptographic hash may be accessed from the distributed ledger as evidence of the particular value that was shared.

The inventors have recognized and appreciated that scalability challenges may arise if hashes of individual attribute values are stored on a distributed ledger. For instance, if a source entity shares an attribute value with multiple recipient entities, a different hash of the attribute value may be generated for each recipient entity (e.g., by combining the attribute value with a different salt corresponding to the recipient entity). This may be done to avoid revealing that the same attribute value was shared with the different recipient entities. Therefore, if the source entity shares M attribute values with each of N recipient entities, M× N hashes may be stored on the distributed ledger. This may result in a large amount of data to be synchronized among a network of nodes, and thus a large number of messages to be exchanged among the network nodes, which may in turn limit a transaction rate of the network (e.g., a number of transactions that may be processed each second).¹

Accordingly, in some embodiments, a hash of a plurality of attribute values may be stored on a distributed ledger, instead of hashes of individual attribute values. For instance, if a source entity shares a set of M attribute values with each of N recipient entities, a different hash of the set of M attribute values may be generated for each recipient entity (e.g., by combining the set of M attribute values with a different salt corresponding to the recipient entity). As a result, only N hashes may be stored on the distributed ledger. This may reduce an amount of data to be synchronized among a network of nodes, thereby reducing a number of messages to be exchanged among the network nodes, which may in turn increase a transaction rate of the network (e.g., a number of transactions that may be processed each second).

However, the inventors have also recognized and appreciated that hashing individual attribute values may provide more flexibility. For instance, in some embodiments, a hash of an attribute value may be signed by a trust entity to evidence that the trusted entity has verified the attribute value (e.g., by examining one or more physical documents). If the trusted entity attests to a set of attribute values by signing a hash of the entire set of attribute values (e.g., name, date of birth, and address, together), instead of signing hashes of individual attribute values (e.g., name, date of birth, and address, separately), a change to a single attribute value (e.g., address) may render the trusted entity's attestation invalid, even if one or more other attribute values (e.g., name and date of birth) remain unchanged.

Accordingly, in some embodiments, multiple layers of hashing may be performed to provide both efficiency and flexibility. For instance, attribute values may be individually hashed and signed by a trusted entity. These individual attribute attestations may be organized into one or more badges, which may then be separately hashed and signed by the trusted entity. In this manner, efficiency may be provided by storing badge attestations, instead of individual attribute attestations, on a distributed ledger, while flexibility may be provided by allowing individual attribute attestations to be re-used. For example, a change to a single attribute value (e.g., address) may render a corresponding attestation invalid, but attestations of one or more other attribute values (e.g., name and date of birth) may remain valid, as long as those other attribute values remain unchanged.

The inventors have recognized and appreciated that sharing of information among entities may be facilitated by representing the information in a structured manner. Accordingly, in some embodiments, knowledge structures may be used that describe relationships between concepts. For instance, a knowledge structure may include a triple comprising a subject, a predicate, and an object. An attribute of an entity may be modeled as a predicate, so that a triple may be of this form: <entity, attribute, value>. As an example, a knowledge structure may include this triple, «#alice>, <#dob>, 1995 Jan. 1>, which may represent a statement that a person denoted by <#alice> has a date of birth of Jan. 1, 1995.

Additionally, or alternatively, an attribute of an entity may be modeled as a subject and/or an object, as opposed to a predicate. For instance, in some embodiments, a “hasAttribute” predicate and a “hasValue” predicate may be provided. Two triples may be formed: <entity, hasAttribute, attribute> and <attribute, hasValue, value>. As an example, a knowledge structure may include these triples: «#alice>, hasAttribute, <#alice-dob» and «#alice-dob>, has Value, 1995 Jan. 1>.

The inventors have recognized and appreciated that, by modeling an attribute as a subject and/or an object, a class definition in a suitable ontology may be provided for the attribute. For instance, a class may be provided that includes one or more properties, which may be used to capture data associated with the attribute. Below is an illustrative Resource Description Framework (RDF) implementation of the <#alice-dob> attribute in the above example.

<#alice-dob>

| | |
|---|---|
| rdf:ID | ″b470c66f-fe37-6532-79dc-aff78b00256d″ ; |
| rdf:type | ont:DateOfBirth ; |
| rdf:value | ″1995-01-01″ ; |
| ont:creationDate | ″2018-11-01T08:31:35+00:00″ ; |
| ont:hasAttestation | <https://example.org/attestations#682456ff- |

d962-46ec-9063-666eba0468bf> .

In this example, a class DateOfBirth may be defined to include two properties. The first property, creationDate, may be used to store a date on which the <#alice-dob> attribute was created. The second property, hasAttestation, may be used to store a pointer to an attestation for a value of the <#alice-dob> attribute. One or more other properties may be provided in addition to, or instead or, creationDate and/or hasAttestation. In this manner, any suitable information may be stored in association with the <#alice-dob> attribute. However, it should be appreciated that aspects of the present disclosure are not limited to using a property in a class definition to capture data associated with an attribute, or to modeling an attribute in any particular way.

In some embodiments, a knowledge structure may be used to maintain a collection of data held by an entity. For instance, the entity may be an organization, and the collection of data may include a personnel roster. A knowledge structure corresponding to the collection of data may include the following triples:
«#alice>, hasAttribute, <#alice-dob»
«#alice-dob>, has Value, 1995 Jan. 1>
«#bob>, hasAttribute, <#bob-dob»
«#bob-dob>, has Value, 1992 Feb. 1>
«#carol>, hasAttribute, <#carol-dob»
«#carol-dob>, has Value, 1999 Mar. 1>
«#david>, hasAttribute, <#david-dob»
«#david-dob>, has Value, 2001 Apr. 1>
   However, it should be appreciated that aspects of the present disclosure are not limited to using any particular type of knowledge structure, or any knowledge structure at all.

In some embodiments, a source entity may share some or all of the source entity's data with a recipient entity. The source entity may manipulate the data prior to sharing. Any suitable manipulation may be performed, such as filtering, sorting, transforming, etc. For instance, the above illustrative knowledge structure may be manipulated to generate a new knowledge structure. As one example, the new knowledge structure may include a new attribute indicating whether each person is eligible to vote.
«#alice>, hasAttribute, <#alice-vote»
«#alice-vote>, hasValue, “yes”>
«#bob>, hasAttribute, <#bob-vote»
«#bob-vote>, has Value, “yes”>
«#carol>, hasAttribute, <#carol-vote»
«#carol-vote>, has Value, “yes”>
«#david>, hasAttribute, <#david-vote»
«#david-vote>, hasValue, “no”>

A result of manipulating a collection of data may be referred to herein as a “view” of the data. The inventors have recognized and appreciated that it may be desirable to provide a systematic way of generating different views. For instance, in a data sharing application, a recipient entity may provide, to a source entity, a specification for a desired view. The specification may include executable code for generating the desired view, and/or information that may be used by executable code to generate the desired view. The source entity may apply the specification to the source entity's data collection, and may share a resulting view with the recipient entity.

In some embodiments, a data collection may be maintained using a knowledge structure in a standardized format, such as an RDF format. The inventors have recognized and appreciated that standardizing knowledge structures may allow views to be generated in a systematic way. For instance, a view specification may include one or more queries written in a query language, such as a semantic query language for databases (e.g., SPARQL Protocol and RDF Query Language, also known as SPARQL). To generate a desired view, a source entity may simply apply the one or more queries to the source entity's RDF knowledge structure. Any suitable query may be used, including, but not limited to, a query that returns the entire knowledge structure.

As discussed above, certain non-sensitive data in an entity's data collection may be stored on a distributed ledger. For instance, when a badge is shared with a recipient entity, a cryptographic hash of the badge may be stored on the distributed ledger (e.g., to evidence what is shared, when, with whom, etc.). Additionally, or alternatively, the entity's data collection may include sensitive data. For privacy reasons, the sensitive data may be kept in an off-ledger data store. In some embodiments, the off-ledger data store may be treated as a primary store, where the entire data collection is kept, including the non-sensitive data that is also stored on the distributed ledger. In this manner, the entire data collection may be made available via a single data framework (for example, by issuing queries to the off-ledger data store), while the distributed ledger may maintain a duplicate record of the non-sensitive data.

The inventors have recognized and appreciated that duplicating non-sensitive data (e.g., on-ledger and off-ledger) may create consistency challenges. For instance, a discrepancy may result if a piece of non-sensitive data is updated in an off-ledger data store, but not on a distributed ledger. Similarly, a discrepancy may result if a piece of non-sensitive data is updated on a distributed ledger (e.g., via a smart contract), but not in an off-ledger data store. To avoid such discrepancies, regular crosschecks may be performed, but that may negatively impact performance. Accordingly, in some embodiments, techniques are provided for maintaining a distributed ledger's local state as part of a knowledge structure that also holds an entity's sensitive data. For instance, a distributed ledger client participating in a distributed ledger protocol may be programmed to access information from the knowledge structure, and to use the accessed information to determine whether to accept a transaction. Additionally, or alternatively, the distributed ledger client may be programmed to update the knowledge structure to record accepted transactions. In some embodiments, there may be no smart contract that updates a distributed ledger state.

It should be appreciated that aspects of the present disclosure are not limited to storing sensitive data and non-sensitive data in a same physical data store. In some embodiments, separate physical data stores may be used to store sensitive data and non-sensitive data, respectively. This may provide improved security. However, the separate physical data stores may be part of a same data framework. For instance, a same query may be issued to access multiple pieces of data, where some pieces of data may be accessed from a physical data store for sensitive data, whereas some other pieces of data may be accessed from a physical data store for non-sensitive data. Any one or more suitable database techniques may be used to maintain the separate physical data stores, such as database partitioning and/or federated queries. It should be appreciated that the techniques introduced above and/or discussed in detail below may be implemented in any of numerous ways, as the techniques are not limited to any particular manner of implementation. Examples of implementation details are provided herein solely for purposes of illustration. Furthermore, the techniques disclosed herein may be used individually or in any suitable combination, as aspects of the present disclosure are not limited to any particular technique or combination of techniques.

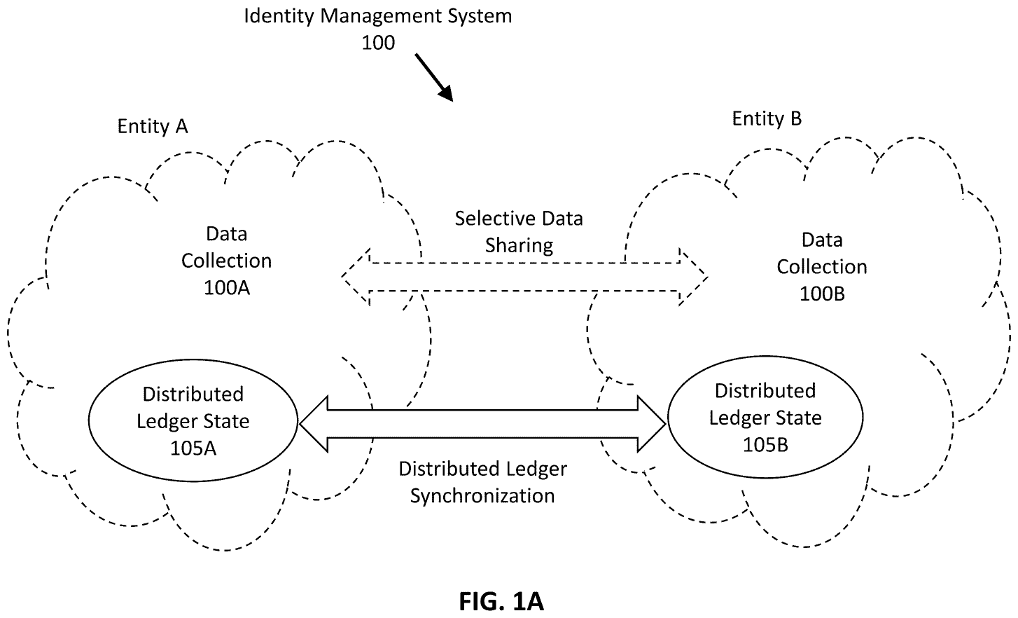

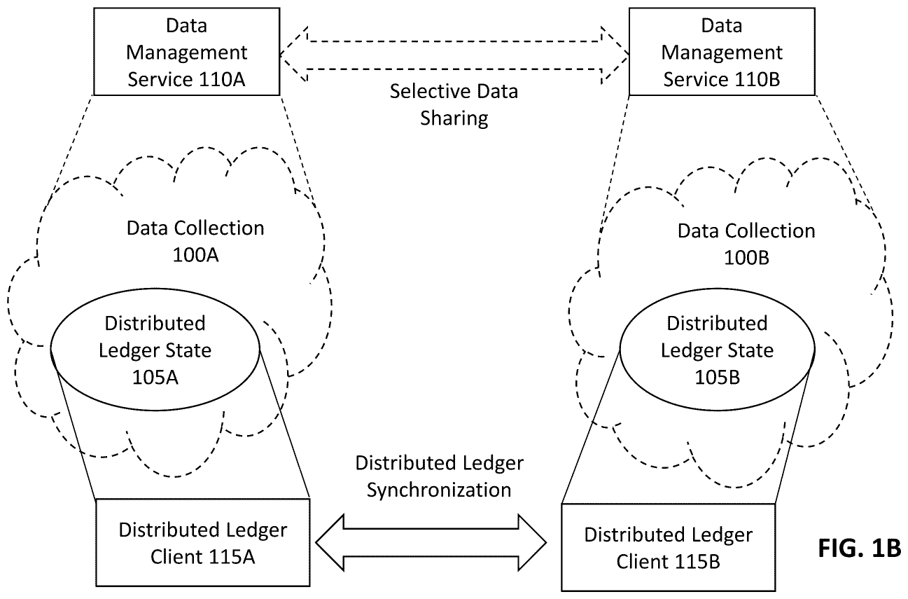

FIG. 1A shows an illustrative data management system 100, in accordance with some embodiments. In this example, the data management system 100 includes data collections 100A and 100B, which may be associated with entities A and B, respectively. Entities of any suitable type may have associated data collections, such as users, organizations, identifiable objects, physical spaces, etc.

In some embodiments, the entity A may selectively share, with the entity B, data in the data collection 100A. Additionally, or alternatively, the entity B may selectively share, with the entity A, data in the data collection 100B. For instance, the entities A and B may perform a handshake and establish a secure communication channel, via which data may be transmitted with end-to-end encryption.

In some embodiments, each of the entities A and B may be associated with one or more nodes in a network of nodes that collectively maintain a distributed ledger. The entity A may publish non-sensitive data (e.g., hashes of sensitive data) to the distributed ledger, so that multiple network nodes in the network may each have a copy of the non-sensitive data. However, instead of maintaining a distributed ledger state 105A that duplicates non-sensitive data in the data collection 100A, the entity A may maintain the distributed ledger state 105A as a part of the data collection 100A. In this manner, there may be no local duplication of the non-sensitive data, so that data consistency crosschecks may no longer be needed, thereby improving efficiency.

In some embodiments, the entity B may also maintain a distributed ledger state (e.g., 105B). The network nodes associated with the entities A and B may participate in a distributed ledger synchronization protocol, so that non-sensitive data published by the entity A may be replicated in the distributed ledger state 105B maintained by the entity B, and non-sensitive data published by the entity B may be replicated in the distributed ledger state 105A maintained by the entity A.

In the example shown in FIG. 1A, the entity B maintains the distributed ledger state 105B as a part of the data collection 100B. In this manner, there may be no need to update the data collection 100B when the distributed ledger state 105B changes upon synchronization.

Although the inventors have recognized and appreciated various advantages of a unified data framework with no local duplication of on-ledger data, it should be appreciated that aspects of the present disclosure are not limited to any particular way of maintaining on-ledger data. FIG. 1B shows illustrative data management services 110A-B and illustrative distributed ledger clients 115A-B, in accordance with some embodiments. For instance, the data management services 110A-B may manage, respectively, the illustrative data collections 100A-B in the example of FIG. 1A. Likewise, the distributed ledger clients 115A-B may manage, respectively, the illustrative distributed ledger states 105A-B in the example of FIG. 1A.

In some embodiments, the data management services 110A-B may communicate with each other via a secure channel (e.g., with end-to-end encryption) to effectuate selective data sharing between the data collections 100A-B. Additionally, or alternatively, the distributed ledger clients 115A-B may participate in a distributed ledger protocol to perform distributed ledger synchronization among a network of nodes.

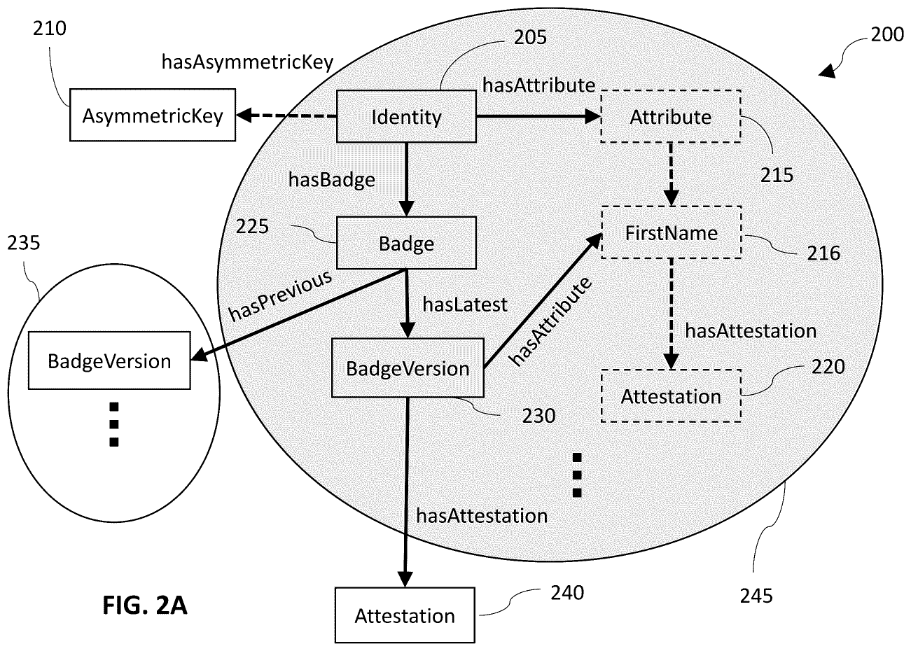

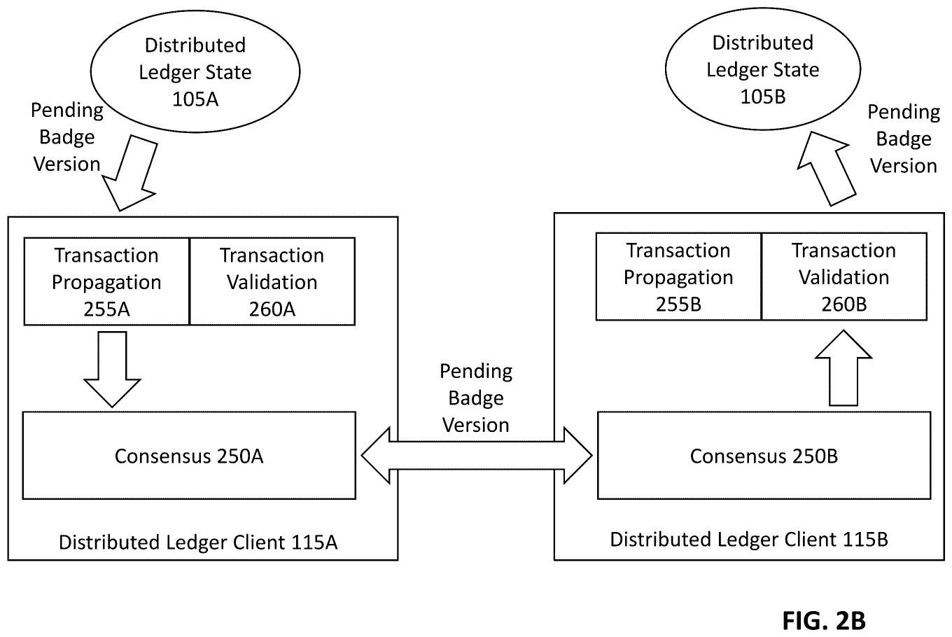

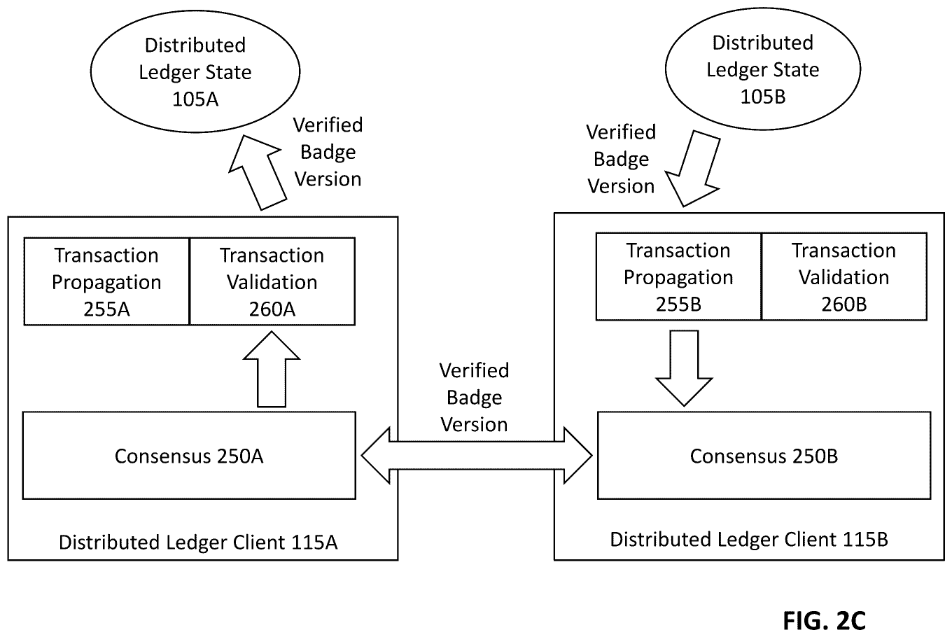

FIG. 2A shows an illustrative knowledge graph 200, in accordance with some embodiments. For instance, the illustrative knowledge graph 200 may be a graphical representation of a portion of the illustrative data collection 100A shown in FIG. 1A.

In the example of FIG. 2A, the knowledge graph 200 includes a plurality of nodes and a plurality of edges. In some embodiments, a node may represent a concept in an appropriate ontology, and may be associated with a class definition in the ontology. The class definition may include one or more properties, thereby allowing relevant data to be stored in association with the node. Accordingly, a node in a knowledge graph may sometime be referred to herein as a “data node.”

In some embodiments, an edge may represent a relationship between concepts in the ontology. For instance, an edge may be associated with a property in a class definition, where the property stores a reference to an instance of another class definition. Accordingly, an edge in a knowledge graph may sometimes be referred to herein as a “pointer.”

In some embodiments, a data collection may be maintained using a knowledge structure in a standardized format, such as a Resource Description Framework (RDF) format. Examples of RDF implementations are provided below for the illustrative data nodes shown in FIG. 2A.²

In the example of FIG. 2A, the knowledge graph 200 includes an Identity node 205, which may be associated with the entity A. Below is an illustrative RDF implementation of a knowledge structure corresponding to the Identity node 205, in accordance with some embodiments.

| # Entity A | |
|---|---|
| <https://example.org/entity#entity-A> | |
| rdf:ID | ″ff058a99-e461-4a55-941d-39a9c83cc2f1″ ; |
| rdf:type | ont:Identity ; |
| ont:creationDate | ″2018-10-01T09:01:23+00:00″ ; |
| # Entity A's identity access key | |
| ont:hasAsymmetricKey <https://example.org/crypto#672a55d3- | |
| 21d5-47f0-91b5-1bbf0ecb79a8> ; | |
| # Entity A's signer key (private state) | |
| ont:hasAsymmetricKey <https://example.org/crypto#3f2a0f62- | |
| 32fe-4cb0-af7d-6ce70bc1419e> ; | |
| ont:hasAttribute | <https://example.org/attributes#10ffdaaa- |
| 50e4-463e-ae41-f5232b5b7d35> ; | |
| ont:hasAttribute | <https://example.org/attributes#43ae8e50- |
| f819-4921-8824-817ee4efbb38> ; | |
| ont:hasBadge | <https://example.org/badges#266ee247- |

c044-4f22-965d-eb3fa4ffdd2b> .

In the above example, the Identity node 205 includes an identifier for the entity A (e.g., ff058a99-e461-4a55-941d-39a9c83cc2f1), a date on which the entity A's identity is created (e.g., 2018-10-01T09: 01:23+00:00), pointers to cryptographic keys associated with the entity A (e.g., <https://example.org/crypto #672a55d3-21d5-47f0-91b5-1bbf0ecb79a8> and <h <https://example.org/crypto #3f2a0f62-32fe-4cb0-af7d-6ce70bc1419e>), pointers to attributes associated with the entity A (e.g., <https://example.org/attributes #10ffdaaa-50e4-463e-ae41-f5232b5b7d35> and <https://example.org/attributes #43ae8e50-f819-4921-8824-817ee4efbb38>), a pointer to a badge associated with the entity A (e.g., <https://example.org/badges #266ee247-c044-4f22-965d-eb3fa4ffdd2b>).

In some embodiments, the cryptographic keys associated with the entity A may include a public and private key pair generated according to a suitable asymmetric cryptosystem. Examples of asymmetric cryptosystems include, but are not limited, to cryptosystems based on elliptic curves (e.g., secp256k1), cryptosystems based on discrete logarithms (e.g., ElGamal), cryptosystems based on decisional composite residuosity (e.g., Paillier), cryptosystems based on factorization (e.g., RSA), etc.

In some embodiments, a public key in a key pair may be used as an identifier on a distributed ledger, and a private key in the key pair may be used to sign transactions to be recorded on the distributed ledger. Additionally, or alternatively, the public key may be used to encrypt messages intended for the entity A, and the private key may be used by the entity A to decrypt the messages. Additionally, or alternatively, the private key may be used by the entity A to sign messages, and the public key may be used to verify the entity A's signatures.

Thus, in some embodiments, a public key infrastructure may be provided via a distributed ledger. For instance, the entity A may send a signed message to a recipient using a same private key that the entity A uses to sign a transaction recorded on the distributed ledger. The recipient may look up the entity A's public key from the distributed ledger, for example, by looking up the transaction signed by the entity A. The recipient may then use the public key to verify the entity A's signature on the received message.

The inventors have recognized and appreciated that it may be advantageous to allow message recipients to look up public keys from transactions recorded on a distributed ledger. However, it should be appreciated that aspects of the present disclosure are not limited to using a distributed ledger to provide a public key infrastructure. In some embodiments, an entity may have separate key pairs for signing transactions and for signing messages, for example, to protect privacy of the entity. These separate key pairs may be generated using a same asymmetric cryptosystem, or different asymmetric cryptosystems.

In some embodiments, the entity A may have an identity access key pair (e.g., <https://example.org/crypto #672a55d3-21d5-47f0-91b5-1bbf0ecb79a8>), which may be used to sign transactions recorded on a distributed ledger. The entity A may also have a signer key pair (e.g., <https://example.org/crypto #3f2a0f62-32fe-4cb0-af7d-6ce70bc1419e>), which may be used to sign messages and/or attestations. The property corresponding to the signer key pair is shown above in bold, indicating that the pointer to the signer key pair is part of the entity A's private state, and is not recorded on the distributed ledger. In this manner, an unauthorized entity may be unable to trace the signer key pair back to the entity A.

Below are illustrative RDF implementations of knowledge structures storing an identity access key pair and a signer key pair associated with the entity A, in accordance with some embodiments.

# Identity access key associated with entity A
<https://example.org/crypto#672a55d3-21d5-47f0-9105-1bbf0ecb79a8>

| | |
|---|---|
| rdf:type | ont:AsymmetricKey ; |
| ont:keyType | ont:SECP256K1 ; |
| ont:scope | ont:FullIdentityOwnerAccess ; |
| ont:pubKey | ″0x70CAd947Df8b12e8C6AE01D7aF |

```
07D18feE9e0EE1″ ;
  # Private key (private state)
  ont:privKey
″5ccb5485b690167360b8a60302b82f4743a0578c10d0092d0ba31e7edd
792546 ″ .
# Signer key associated with entity A
<https://example.org/crypto#3f2a0f62-32fe-4cb0-af7d-6ce70bc1419e>
```

| | |
|---|---|
| rdf:type | ont:AsymmetricKey ; |
| ont:keyType | ont:SECP256K1 ; |
| ont:scope | ont:SignerKey ; |
| ont:pubKey | ″0x4cAD2983B64EC91BAa882a3fD |

```
28E5AFa306Be23f ″ ;
  # Private key (private state)
  ont:privKey
″aaced7dfef71e53564d58adf582caa178b60eb38d0b5df863805b3fe35282
dbb ″ .
```

In some embodiments, a portion of the above knowledge structure of the entity A's signer key pair (e.g., all properties except the property shown in bold, corresponding to a private key component) may be part of a public state, and may be recorded on a distributed ledger. However, as discussed above, the pointer maintained by the entity A to this knowledge structure may be private, so that an unauthorized entity may be unable to trace the signer key pair back to the entity A.

Returning to FIG. 2A, the signer key pair in the above example may be represented as an AsymmetricKey node 210. The Identity node 205 may have a pointer pointing to the AsymmetricKey node 210. The pointer may be shown as a dashed arrow, to indicate that the pointer may be stored in a private state of the entity A. Although not shown in FIG. 2A, the identity access key pair in the above example may be represented as another AsymmetricKey node. The Identity node 205 may have a solid pointer pointing to the AsymmetricKey node representing the identity access key pair, to indicate that the pointer may be stored in a public state of the entity A.

In some embodiments, the entity A may have a first name attribute (e.g., <https://example.org/attributes #10ffdaaa-50e4-463e-ae41-f5232b5b7d35>) and a last name attribute (e.g., <https://example.org/attributes #43ae8e50-f819-4921-8824-817ee4efbb38>). The first name attribute may be represented in FIG. 2A as an Attribute node 215, and the Identity node 205 may have a pointer pointing to the Attribute node 215. Although not shown in FIG. 2A, the last name attribute may also be represented as an Attribute node, and the Identity node 205 may have a pointer pointing to that Attribute node.

Below are illustrative RDF implementations of a first name attribute and a last name attribute associated with the entity A, in accordance with some embodiments.

| # First name associated with entity A (private state) | |
|---|---|
| <https://example.org/attributes#10ffdaaa-50e4-463e-ae41- | |
| f5232b5b7d35> | |
| rdf:type | ont:Attribute ; |
| ont:hasLatest | <https://example.org/attribute- |

| version#0195698d-6d4e-4d23-a0e2-1d566d92070b> ; | |
|---|---|
| ont:hasPrevious | ( ) . |

| <https://example.org/attribute-version#0195698d-6d4e-4d23- | |
|---|---|
| a0e2-1d566d92070b> | |
| rdf:type | ont:FirstName ; |
| ont:version | 1 ; |
| rdf:value | ″Jane″ ; |
| ont:hasAttestation <https://example.org/attestations#94ae44a9- | |
| 4a5b-4427-856f-67ef814c0648> . | |
| # Last name associated with entity A (private state) | |
| <https://example.org/attributes#43ae8e50-f819-4921-8824- | |
| 817ee4efbb38> | |
| rdf:type | ont:Attribute ; |
| ont:hasLatest | <https://example.org/attribute- |

| version#ed9a614f-ae80-4362-a413-b2e21057cbe8> ; | |
|---|---|
| ont:hasPrevious | ( ) . |

| <https://example.org/attribute-version#ed9a614f-ae80-4362- | |
|---|---|
| a413-b2e21057cbe8> | |
| rdf:type | ont:LastName ; |
| ont:version | 1 ; |
| rdf:value | ″Doe″ ; |

ont:hasAttestation <https://example.org/attestations#357daf8c-
fd27-409a-80e7-b3800100afc7> .

In this example, the knowledge structure for the Attribute node 215 stores a reference to a latest version of the first name attribute (which may be stored in an ont: hasLatest property), and zero or more references to previous versions of the first name attribute (which may be stored in an ont: hasPrevious property). In some embodiments, each version may be associated with a version number. However, it should be appreciated that aspects of the present disclosure are not limited to any particular way of maintaining versions of an attribute, or to any versioning at all. In some embodiments, each version (except an initial version) may have a pointer to a previous version, thereby forming a linked list of versions.

Referring again to FIG. 2A, the latest version of the first name attribute in the above example may be represented as a FirstName node 216, and the Attribute node 215 may have a pointer pointing to the FirstName node 216. Although not shown, one or more previous versions of the first name attribute may be represented as a set of one or more FirstName nodes, and the Attribute node 215 may have a pointer pointing to each of the one or more FirstName nodes.

In some embodiments, attribute values such as the entity A's first name “Jane” and last name “Doe” may be treated as sensitive data, and may be shared with other entities selectively. Accordingly, in the above example, the knowledge structures for the first name attribute and the last name attribute are shown in bold, to indicate that the knowledge structures may be in a private state of the entity A. Similarly, the Attribute node 215 and the FirstName node 216 are shown as dashed boxes in the example of FIG. 2A. However, the Identity node 205 may have a solid pointer pointing to the Attribute node 215, to indicate that the pointer may be stored in a public state of the entity A.

In some embodiments, an attestation may be stored in a knowledge structure that is separate from, but is linked to, a knowledge structure for a corresponding attribute. For instance, in the above example, the knowledge structure for the latest version of the first name attribute may include a pointer (e.g., <https://example.org/attestations #94ae44a9-4a5b-4427-856f-67ef814c0648>) pointing to a knowledge structure storing an attestation of the first name of the entity A, and the knowledge structure for the latest version of the last name attribute may include a pointer (e.g., <https://example.org/attestations #357daf8c-fd27-409a-80e7-b3800100afc7>) pointing to a knowledge structure storing an attestation of the last name of the entity A.

For brevity, a knowledge structure storing an attribute value may sometimes be referred to as an “attribute structure,” whereas a knowledge structure storing an attestation may sometimes be referred to as an “attestation structure.” Below are illustrative RDF implementations of attestation structures for the first and last names of the entity A, in accordance with some embodiments.

# Entity A - FirstName attestation (private state)
<https://example.org/attestations#94ae44a9-4a5b-4427-856f-
67ef814c0648>

| | |
|---|---|
| rdf:type | ont:AttributeAttestation ; |

```
  ont:salt
″8bf86c4dba8411da97c0370ff6554eacdb4703225318462217cf94ebecfa
18bab02d121e8e405b3eb1e40393968d5582″ ;
  # Salted hash of identity, attribute, and/or attribute version sub-graphs,
and/or references thereto and/or properties therein
  ont:proof
″72163c095fa56594093701be5c0984156e7014adf950eb67f395f81d510
fdf3288f82db2c3f54f893f1f492bd027f0d9″ ;
  ont:proofAlgo ″HMAC_SHA384″ ;
  ont:creationDate ″2018-10-29T09:01:23+00:00″ ;
  ont:expirationDate ″2019-10-29T09:01:23+00:00″ ;
  # Entity B's signer key
```

| | |
|---|---|
| ont:hasSigner | <https://example.org/crypto#347624af- |

```
5263-4869-95c0-aeae5faffc43> ;
  # Signature of this sub-graph, excluding ont:signature field
  ont:signature
″14c4a03221223893501fe41742229fd5a5b5330e8fc4a55e4e37fdedc9f
85c611d074e7241255a311345e18c791d712021d2afbd3a383b29e450ba
3e30e645c61b″ .
# Entity A - LastName attestation (private state)
<https://example.org/attestations#357daf8c-fd27-409a-80e7-
b3800100afc7>
```

| | |
|---|---|
| rdf:type | ont:AttributeAttestation ; |

```
  ont:salt
″74eb1b4d154ebd1e18dff85b9dc6702732d04a240a3eb83542eebc3529e
68286da8f392ec30981fe29eb4dd5b227fdfd″ ;
  # Salted hash of identity, attribute, and/or attribute version sub-graphs,
and/or references thereto and/or properties therein
  ont:proof
″1eb9a259125fdb614685b1767725850661aeffb1777a4fab0cfc2822470
36e36636ae80520d2a0c0ebede0ab917de401″ ;
  ont:proofAlgo ″HMAC_SHA384″ ;
  ont:creationDate  ″2018-10-29T09:01:23+00:00″ ;
  ont:expirationDate ″2019-10-29T09:01:23+00:00″ ;
  # Entity B's signer key
```

| | |
|---|---|
| ont:hasSigner | <https://example.org/crypto#347624af-5263- |

```
4869-95c0-aeae5faffc43> ;
  # Signature of this sub-graph, excluding ont:signature field
  ont:signature
″345074ada6ace4cb472339fb3ca0437f9960fc09738d419becfe878d899
125da0220474cc38466e7f0a0b7b52d136aca7734a0f43a5febccf6eb7b34
1a776a491b″ .
```

In some embodiments, an attestation of an individual attribute version may be stored in a private state of an entity. Accordingly, in the above example, the knowledge structures for the first name attestation and the last name attestation are shown in bold, to indicate that the knowledge structures may be in a private state of the entity A. Similarly, the Attestation node 220 is shown as a dashed box in the example of FIG. 2A.

By contrast, as discussed below, an attestation of a badge version associated with an entity may, in some embodiments, be part of a public state of the entity, and may be recorded on a distributed ledger, where the badge version may include pointers to one or more attribute versions of the entity. The inventors have recognized and appreciated that, by storing on a distributed ledger only an attestation of a badge version, as opposed to attestations of individual attribute versions, an amount of data to be synchronized among a network of nodes maintaining the distributed ledger may be reduced, thereby improving efficiency. However, it should be appreciated that aspects of the present disclosure are not so limited. In some embodiments, attestations of individual attribute versions may be stored on a distributed ledger in addition to, or instead of, an attestation of a badge.

In some embodiments, an attestation structure for an attribute (e.g., first name) may store a cryptographic proof of a value of the attribute (e.g., “Jane”). For instance, the attestation structure for the first name attribute in the above example may store a cryptographic proof (e.g., 72163c095fa56594093701be5c0984156e7014adf950eb67f395f81d510fdf3288f82db2c3f54f893 f1f492bd027f0d9) generated based on one or more data structures. Examples of data structures used to generate the cryptographic proof include, but are not limited to, the identity node 205 (e.g., <https://example.org/entity #entity-A>), the Attribute node 215 (e.g., <https://example.org/attributes #10ffdaaa-50e4-463e-ae41-f5232b5b7d35>), the FirstName node 216 (e.g., <https://example.org/attribute-version #0195698d-6d4e-4d23-a0e2-1d566d92070b>), references to these sub-graphs, and/or properties in these sub-graphs (e.g., ont: creationDate, ont: hasAsymmetricKey, etc.).

Likewise, the attestation structure for the last name attribute in the above example may store a cryptographic proof (e.g., 1eb9a259125fdb614685b1767725850661aeffb1777a4fab0cfc282247036e36636ae80520d2a0c0 ebede0ab917de401) generated based on one or more data structures. Examples of data structures used to generate the cryptographic proof include, but are not limited to, the identity node 205 (e.g., <https://example.org/entity #entity-A>), the Attribute node for the last name attribute (e.g., <https://example.org/attributes #43ae8e50-f819-4921-8824-817ee4efbb38>), the LastName node (e.g., <https://example.org/attribute-version #ed9a614f-ae80-4362-a413-b2e21057cbe8>), references to these sub-graphs, and/or properties in these sub-graphs (e.g., ont: creationDate, ont: hasAsymmetricKey, etc.).

In some embodiments, a cryptographic proof may be generated such that it may be challenging for an attacker to find any attribute value that would have generated the cryptographic proof. This property may sometimes be referred to as “preimage resistance.” Additionally, or alternatively, a cryptographic proof may be generated such that, given an attribute value that generated the cryptographic proof, it may be challenging for an attacker to find another attribute value that would have generated the same cryptographic proof. This property may sometimes be referred to as “second preimage resistance.” However, it should be appreciated that aspects of the present disclosure are not limited to any particular way of generating cryptographic proofs, or any particular property thereof.

In some embodiments, an attestation structure may store information indicating how an attestation was generated. For instance, in the above example, the attestation structure for the FirstName node 215 stores an indication of an algorithm (e.g., HMAC_SHA384) and a salt (e.g., 8bf86c4dba8411da97c0370ff6554eacdb4703225318462217cf94ebecfa18bab02d121e8e405b3eb le40393968d5582) used to generate the attestation. In some embodiments, the salt may be a random value that was combined with one or more data structures prior to applying the algorithm for generating attestations. Thus, different attestations of the same attribute version may be generated using the same algorithm. However, it should be appreciated that aspects of the present disclosure are not limited to using a salt to generate an attestation.

In some embodiments, an attestation structure may store information indicating when an attestation was generated and/or when the attestation may become stale. For instance, in the above example, the attestation structure for the FirstName node 215 stores a creation date (e.g., 2018-10-29T09: 01:23+00:00) and an expiration date (e.g., 2019-10-29T09: 01:23+00:00). In this manner, an entity checking the attestation may be able to confirm whether the attestation has expired. However, it should be appreciated that aspects of the present disclosure are not limited to storing a creation date or an expiration date for an attestation.

In some embodiments, an attestation structure may be signed by a trusted entity, for example, to indicate that the trusted entity has verified an attribute value corresponding to the attestation version. For instance, in the above example, the attestation structure for the FirstName node 215 stores a signature (e.g., 14c4a03221223893501fe41742229fd5a5b5330e8fc4a55e4e37fdedc9f85c611d074e7241255a31 1345e18c791d712021d2afbd3a383b29e450ba3e30e645c61b), which may be generated using a cryptographic key associated with a trusted entity (e.g., the entity B in the example of FIG. 1A). In that respect, the attestation structure may include a property, ont: hasSigner, which may store a reference to a signer key pair of the trusted entity (e.g., <https://example.org/crypto #347624af-5263-4869-95c0-aeae5faffc43>). However, it should be appreciated that aspects of the present disclosure are not limited to storing, in an attribute attestation, a reference to a trusted entity's signer key pair. In some embodiments, a reference to a trusted entity's signer key pair may be stored in a badge attestation structure (e.g., as described below). By virtue of a badge version referencing an attribute version, a signer key pair for the attribute attestation may be inferred from a signer key pair for the badge attestation.

In some embodiments, a signature may be generated over an attestation structure (e.g., the above illustrative attestation structure for the first name attribute), excluding the signature itself. In this manner, the signature may be used not only to check a cryptographic proof of an attribute value, but also other information stored in the attestation structure, such as an indication of an algorithm used to generate the cryptographic proof, a salt, a creation date, an expiration date, etc.

Returning to FIG. 2A, the attestation structure for FirstName node 215 in the above example may be represented as an Attestation node 220, and the FirstName node 215 may have a pointer pointing to the Attestation node 220. The pointer may be shown as a dashed arrow, to indicate that the FirstName node 215, and thus the pointer stored therein, may be part of a private state of the entity A. The Attestation node 220 may be shown as a dashed box, to indicate that the Attestation node 220 may also be part of the private state of the entity A. In some embodiments, an entity may have one or more badges for use in selective data sharing. For instance, a badge may store pointers to one or more attributes of a source entity, and may be shared with a recipient entity to allow the recipient entity to use the pointers to access values of the one or more attributes. In some embodiments, a badge may have one or more versions. For instance, a new version of a badge may be created when an attribute is updated to a new value, and/or when one or more different attributes are shared by the source entity with the recipient entity.

In the example of FIG. 2A, the entity A may have a badge with pointers to the entity A's first name attribute and last name attribute. The badge may be represented as a Badge node 225, and the Identity node 205 may have a pointer pointing to the Badge node 225. Below is an illustrative RDF implementation of a badge associated with the entity A, in accordance with some embodiments.

| # Entity A's badge | |
|---|---|
| <https://example.org/badges#266ee247-c044-4f22-965d- | |
| eb3fa4ffdd2b> | |
| rdf:type | ont:Badge ; |

| ont:creationDate | ″2018-10-26T16:06:46+00:00″ ; |
|---|---|
| ont:hasLatest | <https://example.org/badge- |
| version#f8ecb885-7c17-40b9-b70f-8ee4be54f981> ; | |
| ont:hasPrevious | ( <https://example.org/badge- |

version#e67cdf14-9db1-47c3-8fc1-569ffe925f39> ) .

In this example, the badge of the entity A includes a reference to a latest version of the badge (which may be stored in an ont: hasLatest property), and zero or more references to previous versions of the badge (which may be stored in an ont: hasPrevious property). Each version may be associated with a version number. However, it should be appreciated that aspects of the present disclosure are not limited to any particular way of maintaining versions of a badge, or to any versioning at all. In some embodiments, each version (except an initial version) may have a pointer to a previous version, thereby forming a linked list of versions.

Referring again to FIG. 2A, the latest version of the badge in the above example may be represented as a Badge Version node 230, and the Badge node 225 may have a pointer pointing to the Badge Version node 230. One or more previous versions of the badge in the above example may be represented as a set of one or more BadgeVersion nodes 235, and the Badge node 225 may have a pointer pointing to each of the one or more BadgeVersion nodes 235.

Below is an illustrative RDF implementation of a latest version of a badge associated with the entity A, in accordance with some embodiments.

| # Badge version 2 for entity A | |
|---|---|
| <https://example.org/badge-version#f8ecb885-7c17-40b9-b70f- | |
| 8ee4be54f981> | |
| rdf:type | ont:BadgeVersion ; |
| ont:version | 2 ; |

| ont:hasPreviousVersion <https://example.org/badge- | |
|---|---|
| version#e67cdf14-9db1-47c3-8fc1-569ffe925f39> ; | |
| ont:creationDate | ″2018-10-27T11:33:25+00:00″ ; |
| ont:hasAttribute | <https://example.org/attribute- |

| version#0195698d-6d4e-4d23-a0e2-1d566d92070b> , | |
|---|---|
| <https://example.org/attribute-version#ed9a614f-ae80-4362- | |
| a413-b2e21057cbe8> ; | |
| ont:hasValidationSchema <http://example.org/natural- | |
| person-kyc-process-definition> ; | |
| ont:state | <https://example.org/states#cb630034- |

| 132f-443f-bfd9-e831cb7998fa> ; | |
|---|---|
| ont:hasAttestation | <https://example.org/attestations#19ba362d- |

| f67b-47fb-9ef0-1756e6e193e8> ; | |
|---|---|
| # Private metadata (private state) | |
| ont:hasPrivateMetadata <https://example.org/private- | |
| metadata#615709b7-3231-429c-bc7a-aae343be295b> . | |
| # State of badge version 2 | |
| <https://example.org/states#cb630034-132f-443f-bfd9- | |
| e831cb7998fa> | |
| rdf:type | ont:State ; |
| rdf:value | ″PENDING″ . |

In some embodiments, a badge version may store information that may be used to order a plurality of versions of a badge. For instance, in the above example, the latest version of the badge includes a property, ont: version, which may store a version number (e.g., 2). Additionally, or alternatively, a timestamp may be stored in a property, ont: creationDate, which may be used to order badge versions chronologically. Additionally, or alternatively, a pointer to a previous version of the badge (e.g., <https://example.org/badge-version #e67cdf14-9db1-47c3-8fc1-569ffe925f39>) may be stored in a property, ont: hasPrevious Version.

In some embodiments, a badge version may have one or more associated attribute versions. For instance, in the above example, the latest version of the badge includes a property, ont: hasAttribute, which may store references to a version of the first name attribute of the entity A (e.g., <https://example.org/attribute-version #0195698d-6d4e-4d23-a0e2-1d566d92070b>) and a version of the last name attribute of the entity A (e.g., <https://example.org/attribute-version #ed9a614f-ae80-4362-a413-b2e21057cbe8>). Accordingly, the illustrative Badge Version node 230 shown in FIG. 2A may have a pointer pointing to the FirstName node 216. Although not shown in FIG. 2A, the Badge Version node 230 may also have a pointer pointing to the LastName node representing the latest version of the last name attribute of the entity A.

In some embodiments, a badge version may store information that indicates one or more steps taken by a trusted entity to verify attribute values associated with the badge version. For instance, in the above example, the latest version of the badge includes a property, ont: has ValidationSchema, which may store a reference to a specification of a Know Your Customer (KYC) process (e.g., <http://example.org/natural-person-kyc-process-definition>) used by a trusted entity (e.g., the entity B in the example of FIG. 1A).

In some embodiments, an attestation may be generated for a badge version, in addition to, or instead of, attestations for individual attribute versions. For brevity, an attestation for a badge version may sometimes be referred to herein as a “badge version attestation” or simply “badge attestation,” whereas an attestation for an individual attribute version may sometimes be referred to herein as an “attribute version attestation” or simply “attribute attestation.”

In the above example, the latest version of the badge includes a property, ont: hasAttestation, which may store a reference to a badge version attestation (e.g., <https://example.org/attestations #19ba362d-f67b-47fb-9ef0-1756e6e193e8>). This badge version attestation may be represented as an Attestation node 240 in FIG. 2A, and the Badge Version node 230 may have a pointer pointing to the Attestation node 240.

Below is an illustrative RDF implementation of a badge version attestation for the entity A, in accordance with some embodiments.

# Entity A - badge version attestation
<https://example.org/attestations#19ba362d-f67b-47fb-9ef0-
1756e6e193e8>

| | |
|---|---|
| rdf:type | ont:BadgeAttestation ; |

| | |
|---|---|
| ont:creationDate | ″2018-10-29T09:01:23+00:00″ ; |
| ont:expirationDate | ″2019-10-29T09:01:23+00:00″ ; |
| ont:proofAlgo | ″HMAC_SHA384″ ; |

```
  ont:salt0
″725054a710a12f61372b469af4b47a834d1724dad2ced91c5a5884f087899
381dd05e051915779a082314578598e1d25″ ;
  # Salted hash of identity, badge, badge version, attribute, attribute
version, and/or attribute version attestation sub-graphs, and/or references
thereto and/or properties therein, using ont:salt0
  ont:proof0
″f691c01928c7601f96778f79e8a7a631e66e1190990f4865871a121778d91
8631c50f164c3346356a59dfb334119042e″ ;
  ont:salt1
″3f094a61d6c248189ad296fc0526eb5f02b1557368da4a6290aa4dd436919
5c3d8d5b9bla55541c1be123c3a8a8de411″ ;
  # Salted hash of badge version and/or state sub-graphs, and/or
references thereto and/or properties therein, using ont:salt1
  ont:proof1
″345b37f872a640f5ae6a0fb56183e5b69a30301295a646f7ab01204396863
c10fd4d30614c9b4978906659b5ec1fcd5f″ ;
  # Entity B's signer key
```

| | |
|---|---|
| ont:hasSigner | <https://example.org/crypto#347624af- |

```
5263-4869-95c0-aeae5faffc43> ;
  # Signature of this sub-graph, excluding ont:signature field
  ont:signature
″d3199ca78beb74ebbc5f1d9f6d13c5a89456eef66a0efbdf08d08813abc32
6ae3571587be13879b5b5b45f1287cb39c139c6f0aca0cc2965acf9232e20
bafb091b″ .
```

In some embodiments, an attestation structure for a badge version may be similar to an attestation structure for an attribute. For instance, a class ont: Attestation may be provided in an ontology, with subclasses ont: AttributeAttestation and ont: BadgeAttestation.
ont: Attribute Attestation rdfs: subClassOf ont: Attestation
ont: Badge Attestation rdfs: subClassOf ont: Attestation

In this manner, attribute attestations and badge attestations may share one or more common properties defined under ont: Attestation, such as ont: creationDate, ont: expirationDate, ont: proofAlgo, ont: hasSigner, ont: signature, etc. However, it should be appreciated that aspects of the present disclosure are not limited to using subclasses in an ontology, or any ontology at all.

In some embodiments, an attestation structure for a badge version may include multiple cryptographic proofs. For instance, in the above example, a first cryptographic proof (e.g., f691c01928c7601f96778f79e8a7a631e66e1190990f4865871a121778d918631c50f164c3346356 a59dfb334119042e) may be generated based on one or more data structures, including, but not limited to, the entity A's identity node (e.g., <https://example.org/entity #entity-A>), the badge (e.g., <https://example.org/badges #266ee247-c044-4f22-965d-eb3fa4ffdd2b>), the badge version (e.g., <https://example.org/badge-version #f8ecb885-7c17-40b9-b70f-8ee4be54f981>), the first name attribute (e.g., <https://example.org/attributes #10ffdaaa-50e4-463e-ae41-f5232b5b7d35>), the latest version of the first name attribute (e.g., <https://example.org/attribute-version #0195698d-6d4e-4d23-a0e2-1d566d92070b>), the attestation for the latest version of the first name attribute (e.g., <https://example.org/attestations #94ae44a9-4a5b-4427-856f-67ef814c0648>), the last name attribute (e.g., <https://example.org/attributes #43ae8e50-f819-4921-8824-817ee4efbb38>), the latest version of the last name attribute (e.g., <https://example.org/attribute-version #ed9a614f-ae80-4362-a413-b2e21057cbe8>), the attestation for the latest version of the last name attribute (e.g., <https://example.org/attestations #357daf8c-fd27-409a-80e7-b3800100afc7>), references to these nodes, one or more properties in these nodes (e.g., ont: creationDate, ont: hasAsymmetricKey, etc.), and/or a portion of the knowledge structure for the badge version attestation itself (e.g., one or more of the properties, ont: salt0, ont: proofAlgo, ont: creationDate, and ont: expirationDate). Referring to FIG. 2A, the cryptographic proof may be generated based on a group 245 of data nodes (although the last name attribute and the last name attestation are not shown).

Returning to the above example, a second cryptographic proof (e.g., 345b37f872a640f5ae6a0fb56183e5b69a30301295a646f7ab01204396863c10fd4d30614c9b4978 906659b5ec 1fcd5f) may be generated based on one or more data structures, including, but not limited to, the badge version (e.g., <https://example.org/badge-version #f8ecb885-7c17-40b9-b70f-8ee4be54f981>), the state structure for the badge version (e.g., <https://example.org/states #cb630034-132f-443f-bfd9-e831cb7998fa>), references to these nodes, one or more properties in these nodes (e.g., ont: creationDate, ont: hasAsymmetricKey, etc.), and/or a portion of the knowledge structure for the badge version attestation itself (e.g., one or more of the properties, ont: salt1, ont: proofAlgo, ont: creationDate, and ont: expirationDate).

The inventors have recognized and appreciated that, by publishing a single cryptographic proof for a group of data nodes (instead of publishing cryptographic proofs for individual data nodes), fewer cryptographic proofs overall may be published to a distributed ledger, which may improve efficiency. However, such a scheme may be less flexible. For instance, a new cryptographic proof may be generated whenever a single data node is updated, even if all other data nodes in the group remain the same. Accordingly, a number of data nodes to be included in such a group may be chosen to achieve a desired tradeoff between efficiency and flexibility.

In some embodiments, an attestation structure for a badge version may store an indication of a trusted entity responsible for verifying attribute values associated with the badge version. For instance, the illustrative badge attestation structure in the above example includes a property, ont: hasSigner, which may store a reference to a signer key pair (e.g., <https://example.org/crypto #347624af-5263-4869-95c0-aeae5faffc43>). This signer key pair may belong to a trusted entity (e.g., the entity B in the example of FIG. 1A), which may verify attribute values (e.g., by reviewing physical documents such as passports, driver's licenses, bank statements, utility bills, etc.). Once an attribute value is verified, the trusted entity may sign an attestation structure corresponding to the attribute value (e.g., the illustrative attestation structure described above for the entity A's first name or last name). Additionally, or alternatively, once all attribute values associated with the badge version have been verified, the trusted entity may sign the attestation structure corresponding to the badge version.

The inventors have recognized and appreciated that a trusted entity's privacy may be better protected by storing a reference to a signer key pair of the trusted entity, as opposed to a reference directly to the trusted entity. However, it should be appreciated that aspects of the present disclosure are not so limited. In some embodiments, a reference directly to a trusted entity may be stored in addition to, or instead of, a reference to a signer key pair of the trusted entity.

In some embodiments, a badge version may include sensitive data that is not to be published to a distributed ledger. Such sensitive data may be stored in a separate knowledge structure, and the badge version may point to the separate knowledge structure. For instance, in the above example, the latest version of the badge includes a property, ont: hasPrivateMetadata, which may store a reference to a separate knowledge structure storing private metadata (e.g., <https://example.org/private-metadata #615709b7-3231-429c-bc7a-aae343be295b>). This property may be shown above in bold, to indicate that the reference to the knowledge structure storing private metadata may be in a private state of an entity (e.g., an entity that generated the badge version and/or an entity responsible for verifying the badge version).

Below is an illustrative RDF implementation of a knowledge structure storing private metadata for a badge version, in accordance with some embodiments.

| # Private metadata of badge version (private state) | |
|---|---|
| <https://example.org/private-metadata#615709b7-3231-429c-bc7a- | |
| aae343be295b> | |
| rdf:type | ont:PrivateMetadata ; |
| rdfs:label | ″Customer_ID″ ; |

| ont:isCustomer true ; | |
|---|---|
| ont:custSince | ″2016-12-21T11:35:47+00:00″ . |

In some embodiments, private metadata may be stored a badge version attestation by a trusted entity responsible for verifying a corresponding badge version. For instance, in the above example, the private metadata, as well as the reference thereto, may be in a private state of the entity B. Thus, even though the badge version attestation may be associated with a badge version of the entity A, the property, ont: hasPrivateMetadata, in the badge version attestation may be stored by the entity B, but not the entity A.

As described below, the entity B may delete attribute values shared by the entity A (e.g., to comply with one or more privacy regulations). The inventors have recognized and appreciated that it may be inefficient for the entity B to frequently query the data collection 100A of the entity A. Thus, in some embodiments, the entity B may use the knowledge structure referenced by the property, ont: hasPrivateMetadata, to store metadata for facilitating local searching. Examples of such properties include, but are not limited to, an identifier for the entity A in the entity B's system (e.g., rdfs: label), an indication that the entity A is a customer of the entity B (e.g., ont: isCustomer), a date on which the entity A became a customer of the entity B (e.g., ont: custSince), etc.

The inventors have recognized and appreciated that access control may be simplified by storing private metadata in a separate knowledge structure. However, it should be appreciated that aspects of the present disclosure are not so limited. In some embodiments, private metadata may be stored within a knowledge structure for a badge version, in addition to, or instead of, a separate knowledge structure.

It also should be appreciated that aspects of the present disclosure are not limited to storing any particular type of private metadata for a badge version, or any private metadata at all. For instance, in some embodiments, distributed ledger metadata (e.g., confirmation block data) may be stored in addition to, or instead of, metadata for the entity B.

In some embodiments, a badge version may store information that indicates a state of the badge version. For instance, in the above example, the latest version of the badge includes a property, ont: state, which may store a reference to a state structure (e.g., <https://example.org/states #cb630034-132f-443f-bfd9-e831cb7998fa>). The state structure may store a label such as PENDING, VERIFIED, INVALID, EXPIRED, etc.

Although various knowledge structures are described above in connection with FIG. 2A, it should be appreciated that such knowledge structures are provided solely for purposes of illustration. Aspects of the present disclosure are not limited to storing any particular collection of data in a knowledge structure. Moreover, aspects of the present disclosure are not limited to any particular standardized format for knowledge structures, or any standardized format at all.

In some embodiments, when a badge version is created, an associated state structure may store a PENDING label. Additionally, or alternatively, a notification may be sent to a trusted entity indicated in the badge version (e.g., the entity B) that a badge version is pending the entity B's verification. Such a notification may be sent by a data management service and/or a distributed ledger client (e.g., the illustrative data management service 110A and/or the illustrative distributed ledger client 115A in the example of FIG. 1B).

FIG. 2B shows the illustrative distributed ledger clients 115A-B in the example of FIG. 1B, in accordance with some embodiments. For instance, the distributed ledger clients 115A-B may participate in a distributed ledger protocol, whereby the illustrative distributed ledger states 105A-B may be synchronized. Although not shown, one or more other distributed ledger clients may participate in the distributed ledger protocol in addition to, or instead of, the distributed ledger client 115A and/or the distributed ledger client 115B. Such a distributed ledger client may run on a node in a network of nodes maintaining a distributed ledger.

In the example of FIG. 2B, the distributed ledger client 115A includes a consensus component 250A, a transaction propagation component 255A, and a transaction validation component 260A. Similarly, the distributed ledger client 115B in this example includes a consensus component 250B, a transaction propagation component 255B, and a transaction validation component 260B. However, it should be appreciated that aspects of the present disclosure are not limited to any particular component or combination of components for a distributed ledger client. In some embodiments, a distributed ledger client may have one or more other components in addition to, or instead of, a consensus component, a transaction propagation component, and/or a transaction validation component.

In some embodiments, an update to the distributed ledger state 105A (e.g., by the data management service 110A) may trigger a distributed ledger transaction. For instance, in response to a badge version being created and labeled “PENDING,” the transaction propagation component 255A of the distributed ledger client 115A may invoke the consensus component 250A to propagate the badge version to the distributed ledger client 115B and/or one or more other distributed ledger clients. This may be done using any suitable consensus technique, including, but not limited to, Tendermint, Kafka-based consensus, Redundant Byzantine Fault Tolerance (RBFT), etc.

In response to receiving a distributed ledger state change via the consensus component 250B, the transaction validation component 260B may, in some embodiments, perform one or more validations. For instance, the transaction validation component 260B may validate a new badge version against a class definition ont: Badge Version to determine if one or more properties are present as expected. Additionally, or alternatively, the transaction validation component 260B may validate an attestation of the new badge version against a class definition ont: BadgeAttestation to determine if one or more properties are present as expected (e.g., whether a cryptographic proof in the attestation has been generated using a salt in the attestation and/or one or more other data items according to the class definition ont: Badge Attestation). Additionally, or alternatively, the transaction validation component 260B may check if an entity creating the new badge version is authorized to do so (e.g., based on an authorization structure of a badge with which the badge version is associated).

In response to successfully performing the one or more validations, the transaction validation component 260B may, in some embodiments, generate a query (e.g., insertion, deletion, and/or modification) based on the distributed ledger state change received via the consensus component 250B. This query may be applied to the distributed ledger state 105B, thereby synchronizing the distributed ledger state 105B with the distributed ledger state 105A.

Although the distributed ledger state 105B and the distributed ledger client 115B are shown in FIG. 2B and discussed above, it should be appreciated that aspects of the present disclosure are not limited to synchronizing the distributed ledger state 105B with the distributed ledger state 105A. Additionally, or alternatively, one or more other copies of the distributed ledger state may be synchronized using one or more respective distributed ledger clients.

In some embodiments, when a trusted entity has verified all attribute values associated with a badge version, the trusted entity may create a new badge version, where an associated state structure may store a VERIFIED label. For instance, in the above example, the entity B (which may act as the trusted party) may use a private key in the signer key pair referenced by the property, ont: hasSigner, to sign an attestation of the new badge version. Additionally, or alternatively, a notification may be sent to the entity A that the entity B has created a verified badge version. Such a notification may be sent by a data management service and/or a distributed ledger client (e.g., the illustrative data management service 110B and/or the illustrative distributed ledger client 115B in the example of FIG. 1B).

FIG. 2C shows the illustrative distributed ledger clients 115A-B in the example of FIG. 1B, in accordance with some embodiments. In this example, the distributed ledger clients 115A-B may participate in a distributed ledger protocol similar to that described above in connection with FIG. 2B. Via this protocol, the verified badge version may be propagated from the illustrative distributed ledger state 105B to the illustrative distributed ledger state 105A.

Although FIGS. 2B-C show distributed ledger clients corresponding, respectively, to entities sharing data with each other (namely, the entities A and B), it should be appreciated that aspects of the present disclosure are not so limited. In some embodiments, a plurality of distributed ledger clients may participate in a distributed ledger protocol to propagate and/or validate transactions independently of any data sharing application. Entities sharing data with each other may publish data to, and/or retrieve data from, the distributed ledger via any distributed ledger client. For instance, the entities A and B may use a same distributed ledger client to publish pending badge versions to, and/or retrieve verified badge versions from, the distributed ledger.

In some embodiments, if a badge owner updates an attribute associated with the badge version, an associated state structure may be updated to store an INVALID label. Additionally, or alternatively, a new badge version may be created. For instance, in the above example, the entity A may update the first name attribute and/or the last name attribute. As a result, the state structure of the current badge version may be updated to store an INVALID label, and a new badge version may be created with a trust structure storing a PENDING label. Additionally, or alternatively, a notification may be sent to the entity B that a new badge version is pending the entity B's verification.

In some embodiments, if an expiration date stored in an attestation of an attribute version associated with a badge version is reached, an associated state structure may be updated to store an EXPIRED label. Additionally, or alternatively, a notification may be sent to the entity B that the badge version has expired and is again pending the entity B's verification. Upon re-verifying all relevant attribute values, the entity B may create a new badge version, where an associated state structure may store a VERIFIED label. For instance, in the above example, the entity B (which may act as the trusted party) may use a private key in the signer key pair referenced by the property, ont: hasSigner, to sign an attestation of the new badge version. Additionally, or alternatively, a notification may be sent to the entity A that the entity B has created a verified badge version.

Attribute version expiration may be detected in any suitable manner. In some embodiments, a check may be performed periodically to determine if the expiration date has been reached. Additionally, or alternatively, a check may be performed whenever the badge version is accessed.

Below is an illustrative RDF implementation of a portion of the data collection 100B associated with the entity B in the example of FIG. 1A, in accordance with some embodiments.

| # Entity B | |
|---|---|
| <https://example.org/entity#entity-B> | |
| rdf:ID | ″88de26cc-3f7e-426a-a89f-384c499d2c57″ ; |
| rdf:type | ont:Identity ; |

| ont:creationDate | ″2018-10-02T08:03:07+00:00″ ; |
|---|---|
| # Entity B's identity access key | |
| ont:hasAsymmetricKey <https://example.org/crypto#48f9ed6b- | |
| 7ac6-4071-8df5-ae488f2670da> ; | |
| # Entity B's signer key (private state) | |
| ont:hasAsymmetricKey <https://example.org/crypto#347624af- | |
| 5263-4869-95c0-aeae5faffc43> ; | |
| ont:hasAttribute | <https://example.org/attributes#282a3699- |
| 6b44-45bc-afac-01cac730c77f> ; | |
| ont:hasAttribute | <https://example.org/attributes#7473f5b2- |
| d675-480c-9658-50086fbcb7b0> ; | |
| ont:hasBadge | <https://example.org/badges#1ab707a4- |

0d57-490b-8022-eb6a76f7fcedb > .

Similar to the illustrative knowledge structure described above for the entity A, the knowledge structure for the entity B in this example includes an identifier for the entity B, a date on which the entity B's identity is created, pointers to cryptographic keys associated with the entity, pointers to attributes of the entity B, and a pointer to a badge associated with the entity A. In some embodiments, the entity B may have an identity access key pair (e.g., <https://example.org/crypto #48f9ed6b-7ac6-4071-8df5-ae488f2670da>), which may be used to sign transactions recorded on a distributed ledger. The entity B may also have a signer key pair (e.g., <https://example.org/crypto #347624af-5263-4869-95c0-aeae5faffc43>), which may be used to sign messages and/or attribute attestations. The key pairs may be generated according to a same asymmetric cryptosystem, or different asymmetric cryptosystems.

In the above example, the property corresponding to the signer key pair is shown in bold, indicating that the pointer to the signer key pair is part of the entity B's private state, and is not recorded on the distributed ledger. In this manner, an unauthorized entity may be unable to trace the signer key pair back to the entity B.

Below are illustrative RDF implementations of knowledge structures storing an identity access key pair and a signer key pair associated with the entity B, in accordance with some embodiments.

# Identity access key pair associated with entity B
<https://example.org/crypto#48f9ed6b-7ac6-4071-8df5-
ae488f2670da>

| | |
|---|---|
| rdf:type | ont:AsymmetricKey ; |
| ont:keyType | ont:SECP256K1 ; |
| ont:scope | ont:FullIdentityOwnerAccess ; |
| ont:pubKey | ″0x1508F5D4cd320002eeEa8ab49Ae76 |

```
27f7D9bA7e8″ ;
  # Private key (private state)
  ont:privKey
″fbb3417cf041ccdc701344029d07c83b65bb0047ce93c2f5585c290
aaaf2112b″ .
# Signer key associated with entity B
<https://example.org/crypto#347624af-5263-4869-95c0-
aeae5faffc43>
```

| | |
|---|---|
| rdf:type | ont:AsymmetricKey ; |
| ont:keyType | ont:SECP256K1 ; |
| ont:scope | ont:SignerKey ; |
| ont:pubKey | ″0x47daa4E80DE74A4c39d2d1Ec58f76 |

```
FbAf040fB73″ ;
  # Private key (private state)
  ont:privKey
″0fa251c6cb9322772fd2a9e1b7804cee8e3e15ad2437daa06dbf04ffe
03e09b8″ .
```

In some embodiments, a portion of the above knowledge structure of the entity B's signer key pair (e.g., all properties except the property shown in bold, corresponding to a private key component) may be part of a public state of the entity B, and may be recorded on a distributed ledger. However, as discussed above, the pointer maintained by the entity B to this knowledge structure may be private, so that an unauthorized entity may be unable to trace the signer key pair back to the entity B.

In some embodiments, the entity B may be an organization, and may have an organization name attribute (e.g., <https://example.org/attributes #282a3699-6b44-45bc-afac-01cac730c77f>) and an organization type attribute (e.g., <https://example.org/attributes #7473f5b2-d675-480c-9658-50086fbcb7b0>). Below are illustrative RDF implementations of an OrgtName attribute and an OrgType attribute associated with the entity B, in accordance with some embodiments.

| # Organization name associated with entity B (private state) | |
|---|---|
| <https://example.org/attributes#282a3699-6b44-45bc-afac- | |
| 01cac730c77f> | |
| rdf:type | ont:OrgName ; |
| rdf:value | ″ABC″ ; |
| ont:hasAttestation <https://example.org/attestations#ca8c9e4a- | |
| 64c9-42b4-a7b1-8210afd34689> . | |
| # Organization type associated with entity B (private state) | |
| <https://example.org/attributes#7473f5b2-d675-480c-9658- | |
| 50086fbcb7b0> | |
| rdf:type | ont:OrgType ; |
| rdf:value | ″Non-Profit″ ; |

ont:hasAttestation <https://example.org/attestations#1f7ef9f9-
460e-4b57-86d7-8d39c68b66a8> .

In some embodiments, attribute values such as the entity B's organization name “ABC” and organization type “Non-Profit” may be treated as sensitive data, and may be shared with other entities selectively. Accordingly, in the above example, the knowledge structures for the OrgName attribute and the OrgType attribute are shown in bold, to indicate that the knowledge structures may be in a private state of the entity B.

In the above example, respective attribute values and references to attribute attestations are stored directly in the illustrative OrgName and OrgType attribute structures. However, it should be appreciated that aspects of the present disclosure are not so limited. In some embodiments, the OrgName and OrgType attribute structures may store references to respective attribute versions similar to the illustrative FirstName and LastName attribute versions in the example of FIG. 2A. The attribute versions may in turn store the respective attribute values and references to attribute attestations.

Below are illustrative RDF implementations of attestation structures for the organization name and the organization type of the entity B, in accordance with some embodiments.

```
# Entity B - OrgName attestation (private state)
<https://example.org/attestations#ca8c9e4a-64c9-42b4-a7b1-8210afd34689>
  rdf:type  ont:AttributeAttestation ;
  ont:salt
“3541411df716e39c46170f0cf569a5e185ec6972d1ca28882f78a36fbcc83197d727c2bd
b36a122b2518342f3ddc3f15” ;
  # salted hash of identity and/or attribute sub-graphs (e.g.,
<https://example.org/attributes#282a3699-6b44-45bc-afac-01cac730c77f>)
  ont:proof
“af0ed2c0ced08a6a7b402cbb171c78293cdaba11e1ea1305072f3de9aaedb839edfa122
fb3eb790019e582126685e85c” ;
  ont:proofAlgo  “HMAC_SHA384” ;
  ont:creationDate  “2018-10-27T08:01:21+00:00” ;
  ont:expirationDate  “2020-10-27T08:05:21+00:00” ;
  # Signature of this sub-graph, excluding ont:signature field
  ont:signature
“e7773fabb601a0ed970d5db12bbfae2424ebb9ce9a8f4d1e0d8a0f5ec50b77f86be1571
6fbbc11ff93dd86fa0a02ae14a6feff09af85f6f2211ef7b47033e99e1b” .
# Entity B - OrgType attestation (private state)
<https://example.org/attestations#1f7ef9f9-460e-4b57-86d7-8d39c68b66a8>
  rdf:type  ont:AttributeAttestation ;
  ont:salt
“de4202b63b22812e43b06cdf2067198b04e1ebb13ce514f169edaf2cc9e9cbf27135534
b8895448743890041654a91d9” ;
  # salted hash of identity and/or attribute sub-graphs (e.g.,
<https://example.org/attributes#7473f5b2-d675-480c-9658-50086fbcb7b0>)
  ont:proof
“a700bf4663a85a25705b9450a8fff5aad0de5baee9a7b8232b730146ed096204cd0dc8e
3a5db9911c40fab4d9601b546” ;
  ont:proofAlgo  “HMAC_SHA384” ;
  ont:creationDate  “2018-10-27T08:01:21+00:00” ;
  ont:expirationDate  “2020-10-27T08:05:21+00:00” ;
  # Signature of this sub-graph, excluding ont:signature field
  ont:signature
“7c40013d2dc053d9212bd52f4bb64c303f74031bf46c3c8e13e4fc00481e063c6f89f0cb
e5f33b46682774957ee5229c18c95eb3457f7c8b2ee2246686c42b751b” .
```

Below is an illustrative RDF implementation of a badge associated with the entity B, in accordance with some embodiments.

```
# Entity B's badge
<https://example.org/badges#1ab707a4-0d57-490b-
8022-eb6a76f7fcedb>
  rdf:type  ont:Badge ;
  ont:hasLatest  <https://example.org/badge-version#
26e99597-f956-41d0-ab11-a485db477113> .
```

Below is an illustrative RDF implementation of a latest version of a badge associated with the entity B, in accordance with some embodiments.

```
# Badge version 1 - published by entity B with entity A as signer
<https://example.org/badge-version#26e99597-f956-41d0-ab11-
a485db477113>
  rdf:type  ont:BadgeVersion ;
  ont:version  1 ;
  ont:modificationDate  “2018-10-26T16:06:46+00:00” ;
  ont:hasAttribute  <https://example.org/attributes#282a3699-6b44-45bc-
afac-01cac730c77f> ,
<https://example.org/attributes#7473f5b2-d675-480c-9658-50086fbcb7b0> ;
  ont:hasSigner  <https://example.org/crypto#3f2a0f62-32fe-4cb0-af7d-
6ce70bc1419e> ;
  ont:state  “PENDING” ;
  ont:hasAttestation <https://example,org/attestations#f1f74b75-3386-4dc0-
a6dc-439f3e6d0644> .
```

Below is an illustrative RDF implementation of a badge version attestation for the entity B, in accordance with some embodiments.

```
# Entity B - badge version attestation
<https://example.org/attestations#f1f74b75-3386-4dc0-
a6dc-439f3e6d0644>
  rdf:type  ont:BadgeAttestation ;
  ont:salt
“644a394cd31effcbae8ef375195c15731fa985bab
9537830045eb1f812fabd2061d5
f66503ac8b5f81f83d2e120c0002” ;
  # Salted hash of identity, badge, badge version, attribute,
attribute version, and/or attribute version attestation sub-graphs,
and/or references thereto and/or properties therein
  ont:proof
“c56ba8542ee39ef1a293cc30ffa765887f6bf893d764d18698bf4a
9dac71450453d9c1611cc7c3d23deb8f4e1e324e43” ;
  ont:proofAlgo  “HMAC_SHA384” ;
  ont:creationDate  “2018-10-27T08:01:21+00:00” ;
  ont:expirationDate  “2020-10-27T08:05:21+00:00” ;
  # Signature of this sub-graph, excluding ont:signature field
  ont:signature
“9d3e9ee0c6e3c0470994d9472bf502822d9b4b520d54fe492a
979469cb0890667d50964370fa285345c6fa68dfbea1d781455f
2142d291eb29d663b879ebd0191b” .
```

In the above example, a state label (e.g., PENDING) is stored directly in the illustrative badge version. However, it should be appreciated that aspects of the present disclosure are not so limited. In some embodiments, the badge version may store a reference to a state structure similar to the illustrative state structure described above in connection with the example of FIG. 2A. The state structure may in turn store the state label. Additionally, or alternatively, the illustrative badge attestation above may store multiple cryptographic proofs (e.g., a first cryptographic proof generated based on private data such as attribute, attribute version, attribute attestation, etc., and a second cryptographic proof generated based on public data such as badge, badge version, badge attestation, etc.).

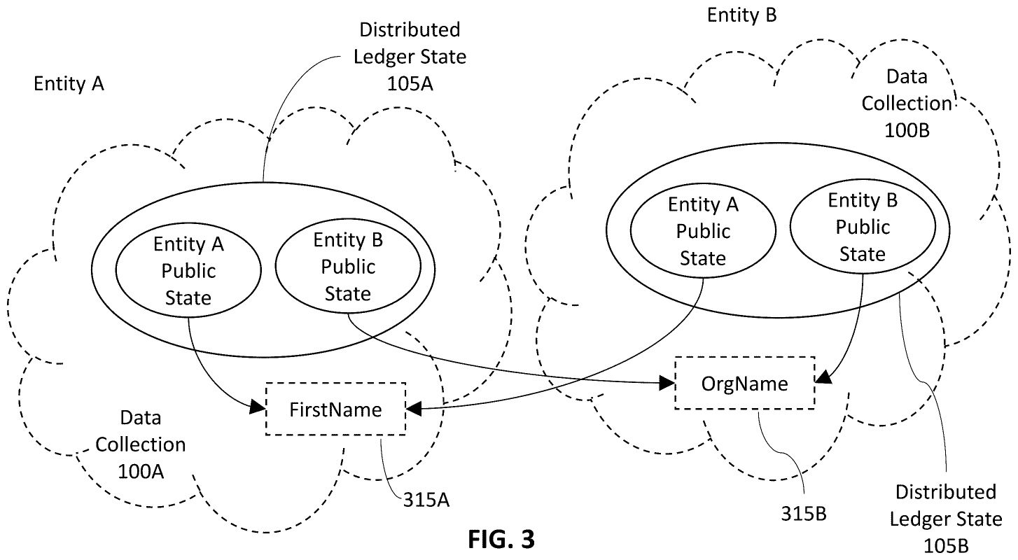

FIG. 3 shows various features of the illustrative data management system 100 in the example of FIG. 1A, in accordance with some embodiments. As described above, the data management system 100 in this example includes the data collections 100A and 100B, which are associated with the entities A and B, respectively.

In some embodiments, network nodes associated with the entities A and B may participate in a distributed ledger synchronization protocol. The entity A may maintain the distributed ledger state 105A as a part of the data collection 100A, and the entity B may maintain the distributed ledger state 105B as a part of the data collection 100B. The distributed ledger states 105A and 105B may be synchronized via the distributed ledger synchronization protocol.

In some embodiments, the distributed ledger states 105A and 105B may be local copies of a global state shared by all network nodes participating in the distributed ledger synchronization protocol. However, that is not required. In some embodiments, the distributed ledger states 105A and 105B may be local copies of a state that is shared only between the entities A and B, or among a selected group of entities including the entities A and B.

In some embodiments, the entity A and/or the entity B may publish non-sensitive data to the distributed ledger. Non-sensitive data published by the entity A to the distributed ledger may sometimes be part of a public state of the entity A, and likewise for the entity B. For instance, with reference to the illustrative knowledge structures described above, properties that are not shown in bold may be part of an entity's public state.

In some embodiments, a public state of the entity A may be replicated in the distributed ledger state 105B maintained by the entity B, for example, via the distributed ledger synchronization protocol. Likewise, a public state of the entity B may be replicated in the distributed ledger state 105A maintained by the entity A.

In the example of FIG. 3, sensitive data that is not published to the distributed ledger may be shown in dashed lines. For instance, the illustrative first name attribute version described above in connection with FIG. 2A may be shown as a dashed box 315A within the data collection 100A. Similarly, the illustrative organization name attribute described above in connection with FIG. 2A may be shown as a dashed box 315B within the data collection 100B.

In some embodiments, although the first name attribute version 315A may be part of a private state of the entity A, a pointer to the first name attribute version 315A may be part of the public state of the entity A. For instance, the first name attribute version 315A may correspond to the illustrative FirstName node 216 in the example of FIG. 2A. The illustrative Badge Version node 230 shown in FIG. 2A may store a pointer to the illustrative FirstName node 216, and the pointer may be part of the public state of the entity A.

Likewise, in some embodiments, although the organization name attribute structure 315B may be part of a private state of the entity B, a pointer to the organization name attribute structure 315B may be part of the public state of the entity B. For instance, a badge version of the entity B may store a pointer to the organization name attribute structure 315B, and the pointer may be part of the public state of the entity B.

In some embodiments, although the first name attribute version 315A may not be stored by the entity B, the entity B may use a pointer in the public state of the entity A to access the first name attribute version 315A. The entity B may have access to such a pointer because the public state of the entity A is replicated in the distributed ledger state 105B. In some embodiments, the entity B's system may be programmed to use the pointer to request the first name attribute version 315A from the entity A via a secure channel. Once the first name attribute version 315A has been received and used for a suitable purpose (e.g., attribute value verification), the entity B's system may delete the first name attribute version 315A. This may facilitate compliance with one or more privacy regulations. However, it should be appreciated that aspects of the present disclosure are not limited to deleting private data. In some embodiments, private data such as the first name attribute version 315A may be stored in a secure manner.

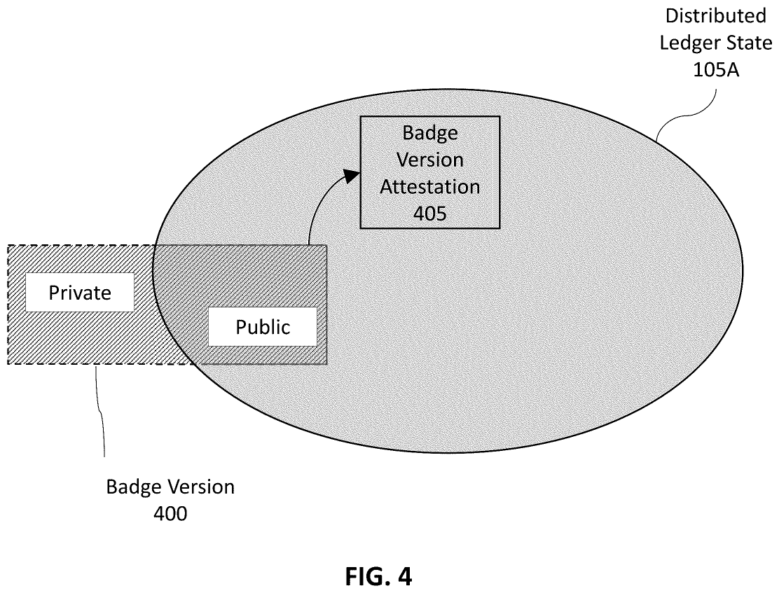

FIG. 4 shows an illustrative badge version 400, in accordance with some embodiments. For instance, the badge version 400 may be associated with the entity A in the example of FIG. 1A, and may correspond to the illustrative Badge Version node 230 shown in FIG. 2A and described above.

In some embodiments, a portion of the badge version 400 may be part of a private state of the entity A and/or the entity B. For instance, in the example of FIG. 2A, the property, ont: hasPrivateMetadata, in the knowledge structure for the BadgeVersion node 230 may be private.

In some embodiments, a portion of the badge version 400 may be part of a public state. For instance, in the example of FIG. 2A, all properties except the property, ont: hasPrivateMetadata, in the knowledge structure for the BadgeVersion node 230 may be part of the public state shared among the network of nodes maintaining the distributed ledger.

In some embodiments, the badge version 400 may have a badge version attestation 405. For instance, the badge version attestation 405 may correspond to the illustrative Attestation node 240 shown in FIG. 2A and described above. In some embodiments, the badge version attestation 405 may be part of the public state of the entity A.

It should be appreciated that aspects of the present disclosure are not limited to having both private and public data in a badge version. In various embodiments, a badge version may store only private data, or only public data.

In some embodiments, one or more of the techniques described herein may be used for data sharing. For instance, a source entity may request that a recipient entity verify values of one or more attributes (e.g., name, address, passport number, annual income, etc.). The recipient entity may verify and attest to the attribute values, for instance, by reviewing physical documents (e.g., the user's passport, tax returns, etc.) and electronically signing an attestation of a badge version associated with the attribute values.

In some embodiments, a source entity may share a collection of sensitive and/or non-sensitive data with a recipient entity, for example, to allow the recipient entity to verify one or more attribute values. The inventors have recognized and appreciated that, by using a unified data framework to manage sensitive and non-sensitive data, a collection of sensitive and/or non-sensitive data may be generated in a systematic manner. For instance, in some embodiments, a source entity may use a query to generate a view to be shared with a recipient entity. The query may be written in a suitable query language, such as a SPARQL Protocol and RDF Query Language (SPARQL). In some embodiments, sensitive data and non-sensitive data may be stored at separate physical data stores (e.g., for improved security), and the query may be a federated query for accessing the separate physical data stores.

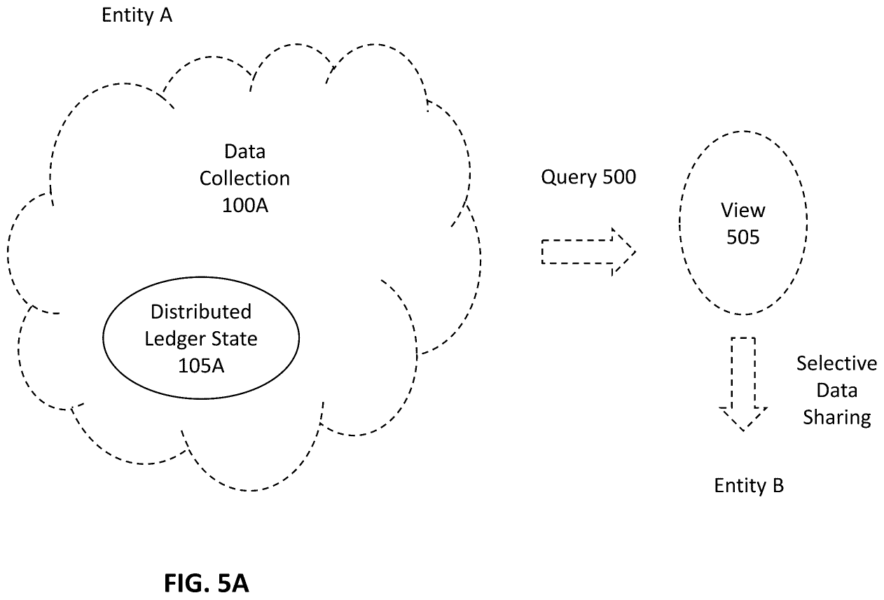

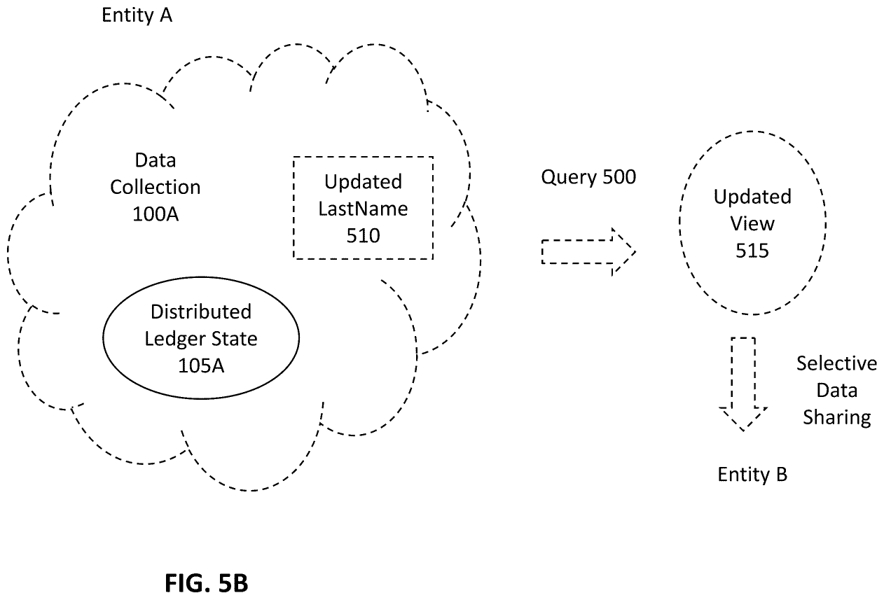

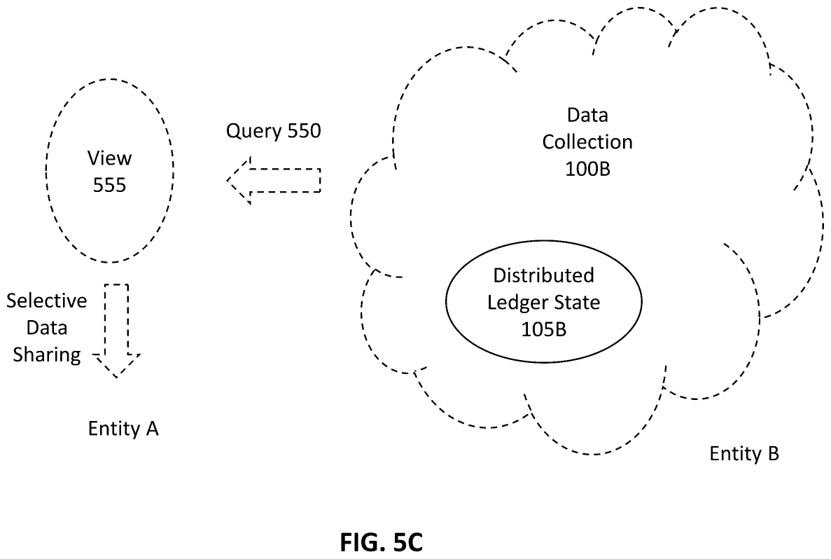

FIG. 5A shows an illustrative query 500, in accordance with some embodiments. For instance, the query 500 may be written to assemble data to be shared by the entity A with the entity B in the example of FIG. 1A. Accordingly, the query 500 may be applied to the illustrative data collection 100A shown in FIG. 1A to generate a view 505, which may then be shared with the entity B via a secure channel (e.g., with end-to-end encryption).

Below is an illustrative SPARQL implementation of the query 500, in accordance with some embodiments.

CONSTRUCT {

| | |
|---|---|
| ?bVersion | rdf:type ?type ; |
| | ?prop ?obj ; |
| | ont:hasAttribute ?aVersion . |
| ?aVersion | rdf:type ?attrType ; |
| | rdf:value ?attrVal . |

} WHERE {
<https://example.org/entity#entity-A> ont:hasBadge ?badge .

| | |
|---|---|
| ?badge | ont:hasLatest ?bVersion . |
| ?bVersion | rdf:type ?type ; |
| | ?prop ?obj ; |
| | ont:hasAttribute ?aVersion . |
| ?aVersion | rdf:type ?attrType ; |
| | rdf:value ?attrVal . |

FILTER(?prop != ont:hasPrivateMetadata)
}

In this example, the query 500 constructs a knowledge structure based on data found in one or more knowledge structures that match one or more conditions. For instance, the query 500, when executed by a query engine, may cause the query engine to look for badges of the entity A. For each such badge, the query engine may further look for a latest version of the badge.

In some embodiments, when a matching knowledge structure is found, the query engine may extract one or more pieces of data from the matching knowledge structure and store the extracted data in a result knowledge structure. The result knowledge structure may then be output as part of a view generated by the query 500. For instance, in the above example, the result knowledge structure includes a type of a matching badge version, one or more attributes associated with the matching badge version, a type and a value of each such attribute, all properties of the matching badge version (except private metadata), etc.

Below is an illustrative view resulting from the query 500, in accordance with some embodiments. For instance, this view may be the illustrative view 505 shown in FIG. 5A.

```
<https://example.org/badge-version#f8ecb885-7c17-40b9-b70f-8ee4be54f981> a
ont:BadgeVersion;
  ont:version 2;
  ont:hasPreviousVersion <https://example.org/badge-version#e67cdf14-9db1-
47c3-8fc1-569ffe925f39>;
  ont:creationDate “2018-10-27T11:33:25+00:00”;
  ont:hasAttribute <https://example.org/attribute-version#0195698d-6d4e-4d23-
a0e2-1d566d92070b>,
    <https://example.org/attribute-version#ed9a614f-ae80-4362-a413-
b2e21057cbe8>;
  ont:hasValidationSchema <http://example.org/natural-person-kyc-process-
definition>;
  ont:state <https://example.org/states#cb630034-132f-443f-bfd9-e831cb7998fa>;
  ont:hasAttestation <https://example.org/attestations#19ba362d-f67b-47fb-9ef0-
1756e6e193e8> .
<https://example.org/attribute-version#0195698d-6d4e-4d23-a0e2-1d566d92070b> a
ont:FirstName;
  rdf:value “Jane” .
<https://example.org/attribute-version#ed9a614f-ae80-4362-a413-b2e21057cbe8> a
ont:LastName;
  rdf:value “Doe” .
```

FIG. 5B shows the illustrative query 500 in the example of FIG. 5A, where the query 500 is re-run in response to an update to an attribute, in accordance with some embodiments. For instance, the illustrative data management service 110A in the example of FIG. 1B may update an attribute of the entity A, such as the last name attribute. This may be done by creating a new last name attribute version, which may trigger an update to one or more badges to which the previous last name attribute version is associated. For example, a new badge version may be created with a state structure storing a PENDING label, and a notification may be sent to the entity B that a new badge version is pending verification. The notification may include an updated view 515 generated by running the query 500 again, against a current version of the data collection 100A.

In some embodiments, the new badge version may store a pointer to the new version of the last name attribute, shown as an updated LastName node 510 in FIG. 5B. Since the new badge version is now the latest version of the badge, the query 500 may capture the new version of the last name attribute, and the new last name may be included in the updated view 515. FIG. 5C shows an illustrative query 550, in accordance with some embodiments. For instance, the query 550 may be written to extract attestations created by the entity B for attribute values of the entity A in the example of FIG. 1A. Accordingly, the query 550 may be applied to the illustrative data collection 100B shown in FIG. 1A to generate a view 555, which may then be shared with the entity A via a secure channel (e.g., with end-to-end encryption). Below is an illustrative SPARQL implementation of the query 550, in accordance with some embodiments.

CONSTRUCT {

| | |
|---|---|
| ?bVersion | rdf:type ?type ; |
| | ont:hasAttribute ?aVersion . |
| ?aVersion | rdf:type ?attrType ; |
| | ont:hasAttestation ?attest . |

```
  ?attest ?prop ?obj .
} WHERE {
  <https://example.org/entity#entity-A> ont:hasBadge ?badge .
```

| | |
|---|---|
| ?badge | ont:hasLatest ?bVersion . |
| ?bVersion | rdf:type ?type ; |
| | ont:hasAttribute ?aVersion . |
| ?aVersion | rdf:type ?attrType ; |
| | ont:hasAttestation ?attest . |

?attest ?prop ?obj
}

Below is an illustrative view resulting from the query 550, in accordance with some embodiments. For instance, this view may be the illustrative view 555 shown in FIG. 5C.

```
<https://example.org/badge-version#f8ecb885-7c17-40b9-b70f-8ee4be54f981> a
ont:BadgeVersion;
  ont:hasAttribute <https://example.org/attribute-version#0195698d-6d4e-4d23-a0e2-
1d566d92070b>,
  <https://example.org/attribute-version#ed9a614f-ae80-4362-a413-b2e21057cbe8> .
<https://example.org/attribute-version#0195698d-6d4e-4d23-a0e2-1d566d92070b> a
ont:FirstName;
  ont:hasAttestation <https://example.org/attestations#94ae44a9-4a5b-4427-856f-
67ef814c0648> .
<https://example.org/attestations#94ae44a9-4a5b-4427-856f-67ef814c0648>
ont:creationDate
    “2018-10-29T09:01:23+00:00”;
  ont:expirationDate “2019-10-29T09:01:23+00:00”;
  ont:proof
“72163c095fa56594093701be5c0984156e7014adf950eb67f395f81d510fdf3288f82db2c3
f54f893f1f492bd027f0d9”;
  ont:proofAlgo “HMAC_SHA384”;
  ont:salt
“8bf86c4dba8411da97c0370ff6554eacdb4703225318462217cf94ebecfa18bab02d121e8e
405b3eb1e40393968d5582 “ ;
  ont:hasSigner <https://example.org/crypto#347624af-5263-4869-95c0-aeae5faffc43>;
  ont:signature
“14c4a03221223893501fe41742229fd5a5b5330e8fc4a55e4e37fdedc9f85c611d074e724
1255a311345e18c791d712021d2afbd3a383b29e450ba3e30e645c61b” .
<https://example.org/attribute-version#ed9a614f-ae80-4362-a413-b2e21057cbe8> a
ont:LastName;
  ont:hasAttestation <https://example.org/attestations#357daf8c-fd27-409a-80e7-
b3800100afc7> .
<https://example.org/attestations#357daf8c-fd27-409a-80e7-b3800100afc7>
ont:creationDate
    “2018-10-29T09:01:23+00:00”;
  ont:expirationDate “2019-10-29T09:01:23+00:00”;
  ont:proof
“1eb9a259125fdb614685b1767725850661aeffb1777a4fab0cfc282247036e36636ae8052
0d2a0c0ebede0ab917de401”;
  ont:proofAlgo “HMAC_SHA384”;
  ont:salt
“74eb1b4d154ebd1e18dff85b9dc6702732d04a240a3eb83542eebc3529e68286da8f392ec
30981fe29eb4dd5b227fdfd”;
  ont:hasSigner <https://example.org/crypto#347624af-5263-4869-95c0-aeae5faffc43>;
  ont:signature
“345074ada6ace4cb472339fb3ca0437f9960fc09738d419becfe878d899125da0220474cc
38466e7f0a0b7b52d136aca7734a0f43a5febccf6eb7b341a776a491b” .
```

In some embodiments, non-sensitive data that has been recorded on a distributed ledger may remain dispersed throughout an entity's data collection, as opposed to being duplicated in a separate data structure for the distributed ledger. As discussed above, this may reduce data consistency crosschecks, thereby improving efficiency. In some embodiments, a query may be provided to extract a distributed ledger state from an entity's data collection.

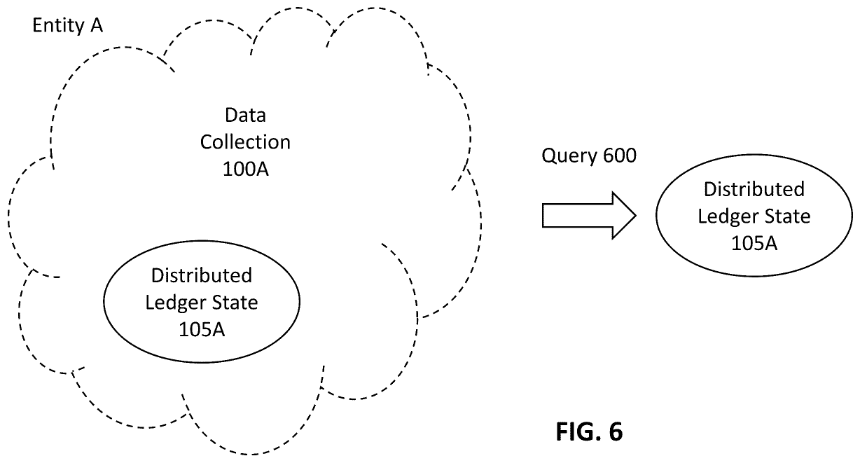

FIG. 6 shows an illustrative query 600, in accordance with some embodiments. For instance, the query 600 may be applied to the illustrative data collection 100A shown in FIG. 1A to generate a view. In this example, the query 600 may be written to extract non-sensitive data of the entity A that has been recorded on a distributed ledger. Thus, the view generated by the query 600 may be the illustrative distributed ledger state 105A.

Below is an illustrative SPARQL implementation of the query 600, in accordance with some embodiments.

CONSTRUCT {

| | |
|---|---|
| ?s | rdf:ID ?id ; |
| | rdf:type ont:Identity ; |
| | ont:creationDate ?date ; |
| | ont:hasBadge ?badge ; |
| | ont:hasAsymmetricKey ?key . |
| ?key | rdf:type ?keyType ; |
| | ont:pubKey ?pubKey ; |
| | ont:scope ont:FullIdentityOwnerAccess . |
| ?badge | ?bProp ?bVersion . |
| ?bVersion | ?bvProp ?bvObj . |

} WHERE {

| | |
|---|---|
| ?s | rdf:ID ?id ; |
| | rdf:type ont:Identity ; |
| | ont:creationDate ?date ; |
| | ont:hasAsymmetricKey ?key . |
| ?key | rdf:type ?keyType ; |
| | ont:pubKey ?pubKey ; |
| | ont:scope ont:FullIdentityOwnerAccess . |

OPTIONAL {

| | |
|---|---|
| ?s | ont:hasBadge ?badge . |

?badge ?bProp ?bVersion .

| | |
|---|---|
| ?bVersion | ?bvProp ?bvObj . |

```
    FILTER(?bvProp != ont:hasPrivateMetadata)
  }
}
```

In this example, the query 600 constructs a knowledge structure based on data found in one or more knowledge structures that match one or more conditions. For instance, the query 600, when executed by a query engine, may cause the query engine to look for knowledge structures having a type, ont: Identity, and an asymmetric key pair with a scope, ont: FullIdentityOwnerAccess.

In some embodiments, when a matching knowledge structure is found, the query engine may extract one or more pieces of data from the matching knowledge structure and store the extracted data in a result knowledge structure. The result knowledge structure may then be output as part of a view generated by the query 600. For instance, in the above example, the result knowledge structure includes an identifier, a creation date, the asymmetric key pair with the scope, ont: FullIdentityOwnerAccess, a key type for the asymmetric key pair, a public key in the asymmetric key pair, etc.

In some embodiments, if one or more pieces of data indicated by the query 600 is not present in a knowledge structure, then the knowledge structure may not be considered a matching knowledge structure. For instance, in the above example, if any of the identifier, the creation date, the asymmetric key pair, the key type, and the public key is missing in a knowledge structure, then the knowledge structure may not be considered a matching knowledge structure.

Additionally, or alternatively, the query 600 may program the query engine to look for one or more pieces of data, but even if such data is missing in a knowledge structure, the knowledge structure may still be considered a matching knowledge structure. For instance, in the above example, the query 600 may program the query engine to see if a matching knowledge structure has a badge. If so, the query engine may look for one or more badge versions of the badge, and may store, in the result knowledge structure, all properties of the one or more badge versions (except private metadata).

Below is an illustrative view resulting from the query 600, in accordance with some embodiments. For instance, this view may be the illustrative distributed ledger state 100A shown in FIG. 1A.

```
<https://example.org/entity#entity-A> a ont:Identity;
  rdf:ID “ff058a99-e461-4a55-941d-39a9c83cc2f1”;
  ont:creationDate “2018-10-01T09:01:23+00:00”;
  ont:hasAsymmetricKey <https://example.org/crypto#672a55d3-21d5-47f0-
91b5-1bbf0ecb79a8>;
  ont:hasBadge <https://example.org/badges#266ee247-c044-4f22-965d-
eb3fa4ffdd2b> .
<https://example.org/crypto#672a55d3-21d5-47f0-91b5-1bbf0ecb79a8> a
ont:AsymmetricKey;
  ont:pubKey “0x70CAd947Df8b12e8C6AE01D7aF07D18feE9e0EE1”;
  ont:scope ont:FullIdentityOwnerAccess .
<https://example.org/badges#266ee247-c044-4f22-965d-eb3fa4ffdd2b>
  ont:hasLatest <https://example.org/badge-version#f8ecb885-7c17-40b9-b70f-
8ee4be54f981>;
  ont:hasPrevious _:node .
_:node
  rdf:first <https://example.org/badge-version#e67cdf14-9db1-47c3-8fc1-
569ffe925f39>;
  rdf:rest rdf:nil .
<https://example.org/badge-version#f8ecb885-7c17-40b9-b70f-8ee4be54f981> a
ont:BadgeVersion;
  ont:version 2;
  ont:hasPreviousVersion <https://example.org/badge-version#e67cdf14-9db1-
47c3-8fc1-569ffe925f39>;
  ont:creationDate “2018-10-27T11:33:25+00:00”;
  ont:hasAttribute <https://example.org/attribute-version#0195698d-6d4e-4d23-
a0e2-1d566d92070b>,
    <https://example.org/attribute-version#ed9a614f-ae80-4362-a413-
b2e21057cbe8>;
  ont:hasValidationSchema <http://example.org/natural-person-kyc-process-
definition>;
  ont:state <https://example.org/states#cb630034-132f-443f-bfd9-
e831cb7998fa>);
  ont:hasAttestation
<https://example.org/attestations#19ba362d-f67b-47fb-9ef0-
1756e6e193e8> .
<https://example.org/entity#entity-B> a ont:Identity;
  rdf:ID “88de26cc-3f7e-426a-a89f-384c499d2c57”;
  ont:creationDate “2018-10-02T08:03:07+00:00”;
  ont:hasAsymmetricKey <https://example.org/crypto#48f9ed6b-7ac6-4071-8df5-
ae488f2670da>;
  ont:hasBadge <https://example.org/badges#1ab707a4-0d57-490b-8022-
eb6a76f7fcedb> .
<https://example.org/crypto#48f9ed6b-7ac6-4071-8df5-ae488f2670da> a
ont:AsymmetricKey;
  ont:pubKey “0x1508F5D4cd320002eeEa8ab49Ae7627f7D9bA7e8”;
  ont:scope ont:FullIdentityOwnerAccess .
<https://example.org/badges#1ab707a4-0d57-490b-8022-eb6a76f7fcedb>
  ont:hasLatest <https://example.org/badge-version#26e99597-f956-41d0-ab11-
a485db477113> .
<https://example.org/badge-version#26e99597-f956-41d0-ab11-a485db477113>
a ont:BadgeVersion;
  ont:version 1;
  ont:modificationDate “2018-10-26T16:06:46+00:00”;
  ont:hasAttribute <https://example.org/attributes#282a3699-6b44-45bc-afac-
01cac730c77f>,
    <https://example.org/attributes#7473f5b2-d675-480c-9658-50086fbcb7b0>;
  ont:hasSigner <https://example.org/crypto#3f2a0f62-32fe-4cb0-af7d-
6ce70bc1419e>;
  ont:state “PENDING”;
  ont:hasAttestation
<https://example.org/attestations#f1f74b75-3386-4dc0-a6dc-
439f3e6d0644> .
```

In the above example, the query 600 returns a current state of a distributed ledger, as opposed to an entire history recorded on the distributed ledger. For instance, instead of returning a knowledge structure storing content from the previous version of the entity A's badge, the query 600 may return a pointer to the previous version of the badge. In this manner, the content may be retrieved if needed. However, it should be appreciated that aspects of the present disclosure are not limited to any particular way of querying for a distributed ledger state.

In some embodiments, a query may be provided to retrieve an entire history recorded on a distributed ledger, in addition to, or instead of, a query that retrieves a current state of the distributed ledger.

In some embodiments, the distributed ledger may include a knowledge structure that stores configuration information for the distributed ledger. Such a knowledge structure is sometimes referred to as a “configuration structure.” As one example, the configuration structure may store one or more class definitions, such as class definitions for ont: Identity, ont: Attribute, ont: Badge, ont: AttributeAttestation, ont: Badge Attestation, ont: hasAsymmetricKey, ont: Authorization, etc. Such a class definition may be provided in a knowledge representation language such as Web Ontology Language (OWL), and/or using a knowledge representation data model such as Resource Description Framework Schema (RDFS). However, it should be appreciated that aspects of the present disclosure are not limited to using any particular class definition format, or any class definition at all.

As another example, the configuration structure may indicate one or more entities that are authorized to modify the configuration structure. For instance, the configuration structure may store a reference to a cryptographic key associated with each such entity. In some embodiments, a threshold cryptography scheme may be used so that at least N entities may need to approve a modification of the configuration structure, for some suitable N ≥1.

In some embodiments, a distributed ledger may be implemented using a blockchain. The blockchain may include a plurality of blocks, where each block may include a plurality of transactions. In some embodiments, the plurality of transactions may be ordered, for example, chronologically. Additionally, or alternatively, the plurality of blocks may be ordered, where each newly added block may be linked to an immediately preceding block. For instance, the newly added block may include a cryptographic hash of the immediately preceding block. In this manner, an attacker may modify an earlier block only by finding a collision for each block between the earlier block and a most recent block. Thus, as a block ages, modification to that block may become computationally more difficult.

In some embodiments, a distributed ledger may be used to confirm whether a given transaction did take place, and/or when the transaction took place. For instance, a block may be added to a blockchain only if all nodes (or a subset of nodes with sufficient computation power) in a network implementing the blockchain agree on the block.

In some embodiments, a block generating node (sometimes called a miner) may invest computation power to generate a new block that is linked to a latest previous block. The node that is able to solve a computationally intensive mathematical puzzle (e.g., identifying a preimage of a hash with a certain number of leading zeros) first may be rewarded with an internal digital asset (e.g., a bitcoin). Depending on how much computation power is available in the network at a given point in time, a more or less complex mathematical puzzle may be used. In this manner, blocks may be generated in a selected time window, and conflicts may be reduced.

It should be appreciated that aspects of the present disclosure are not limited to using a proof-of-work approach as described above. In some embodiments, a proof-of-stake approach may be used to achieve distributed consensus. It should also be appreciated that any suitable blockchain implementation may be used, including, but not limited to, Ethereum and/or Hyperledger Fabric. Furthermore, aspects of the present disclosure are not limited to using a blockchain to implement a distributed ledger. In some embodiments, one or more directed acyclic graphs (e.g. IOTA Tangle), hashgraphs (e.g. Swirlds), hash trees (e.g. Guardtime keyless signatures infrastructure), and/or distributed ledgers with no globally-shared chain (e.g. R3 Corda) may be used in addition to, or instead of, one or more blockchains.

The inventors have recognized and appreciated that a relationship between a first entity and a second entity may be expressed using one or more attributes. For instance, in some embodiments, an identifier for a first entity may be stored in an attribute of a second entity to indicate that the first entity is owned by, or otherwise subordinate to, the second entity. As one example, a “belongsTo” attribute may be provided for an identifiable object, and may store an identifier for an organization to indicate that the organization owns the identifiable object. As another example, a “belongsTo” attribute may be provided for a user, and may store an identifier for an organization to indicate that the user is an employee of the organization.

As another example, an “inCustodyOf” attribute may be provided for an identifiable object, and may store an identifier for a user or an organization to indicate that the identifiable object is in custody of the user or the organization. In some embodiments, the identifiable object may have both a “belongsTo” attribute and an “inCustodyOf” attribute. The “belongsTo” attribute may store an identifier for an owner of the identifiable object, whereas the “inCustodyOf” attribute may store an identifier for a freight carrier that has been hired to transport the identifiable object.

As another example, a “componentOf” attribute may be provided for a first identifiable object, and may store an identifier for a second identifiable object to indicate that the first identifiable object is a component of the second identifiable object. For instance, in some embodiments, a gemstone may have inscribed thereon a serial number and/or other identification information, and therefore may be considered an identifiable object. Likewise, a piece of jewelry may have inscribed thereon a serial number and/or other identification information, and therefore may be considered an identifiable object. A “componentOf” attribute may be provided for the gemstone, and may store an identifier for the piece of jewelry to indicate that the gem stone is set into the piece of jewelry.

Additionally, or alternatively, a package of food ingredient (e.g., a crate of lettuce) may be labeled with a serial number, a lot number, a production line number, a production facility number, a time of production, and/or other identification information, and therefore may be considered an identifiable object. Likewise, a package of food product (e.g., a box of mixed salad) may be labeled with a serial number, a lot number, a production line number, a production facility number, a time of production, and/or other identification information, and therefore may be considered an identifiable object. A “componentOf” attribute may be provided for the package of food ingredient, and may store an identifier for the package of food product to indicate that the food ingredient was used to make the food product.

It should be appreciated that aspects of the present disclosure are not limited to subordinate relationships. In some embodiments, an identifier for a first entity may be stored in an attribute of a second entity to indicate that the first entity is superior to the second entity. For instance, an “includes” attribute may be provided for a first identifiable object (e.g., a piece of jewelry, a package of food product, an electronic system, etc.), and may store an identifier for a second identifiable object (e.g., a gem stone, a package of food ingredient, an electronic component, etc.) to indicate that the second identifiable object is a component of the first identifiable object.

As another example, a piece of software (e.g., a firmware update) may be identified in a suitable fashion (e.g., by generating a hash of a binary image of the firmware update and using the hash as an identifier). A piece of hardware (e.g., a System-on-Chip, also known as SoC) may also be identified in a suitable fashion (e.g., via a serial number and/or a physically-determined fingerprint such as a physically unclonable function, also known as PUF), and therefore may be considered an identifiable object. An “includes” attribute may be provided for the hardware, and may store an identifier for the software to indicate that the software is installed onto the hardware.

As another example, an “includes” attribute may be provided for a piece of binary code, and may store an identifier for a piece of source code to indicate that the source code was used (with or without other source code) to generate the binary code.

In some embodiments, an identifier for a first entity may be stored in an attribute of a second entity to indicate that the first entity is related to the second entity in a manner that is neither subordinate nor superior.

In some embodiments, a “locatedAt” attribute may be provided for an identifiable object (or a user), and may store an identifier for a physical space to indicate that the identifiable object (or the user) is located at the physical space. For instance, a “locatedAt” attribute of an identifiable object (e.g., a gemstone, a piece of jewelry, a package of food ingredient, a package of food product, an electronic component, an electronic system, etc.) may store an identifier for a warehouse, a shipping container, a distribution center, a retail location, etc.

In some embodiments, a data management service may be provided to manage an entity's data collection. For instance, the data management service may perform one or more access control functions. Examples of data management services are described in International Patent Application No. PCT/US2018/055335, filed on Oct. 11, 2018, published as WO 2019/075156 A1 on Apr. 18, 2019, entitled “SYSTEMS AND METHODS FOR MANAGING RELATIONSHIPS AMONG DIGITAL IDENTITIES,” which is incorporated herein by reference in its entirety.³

In some embodiments, a separate instance of a data management service may be provided for each entity. However, that is not required. In some embodiments, a data management service may manage data collections for multiple entities.

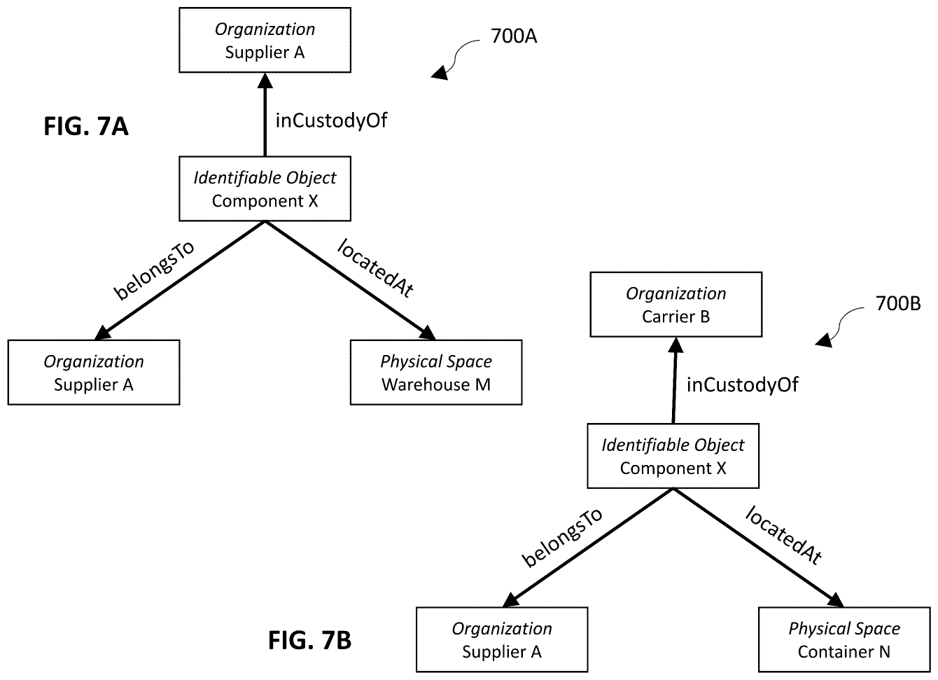

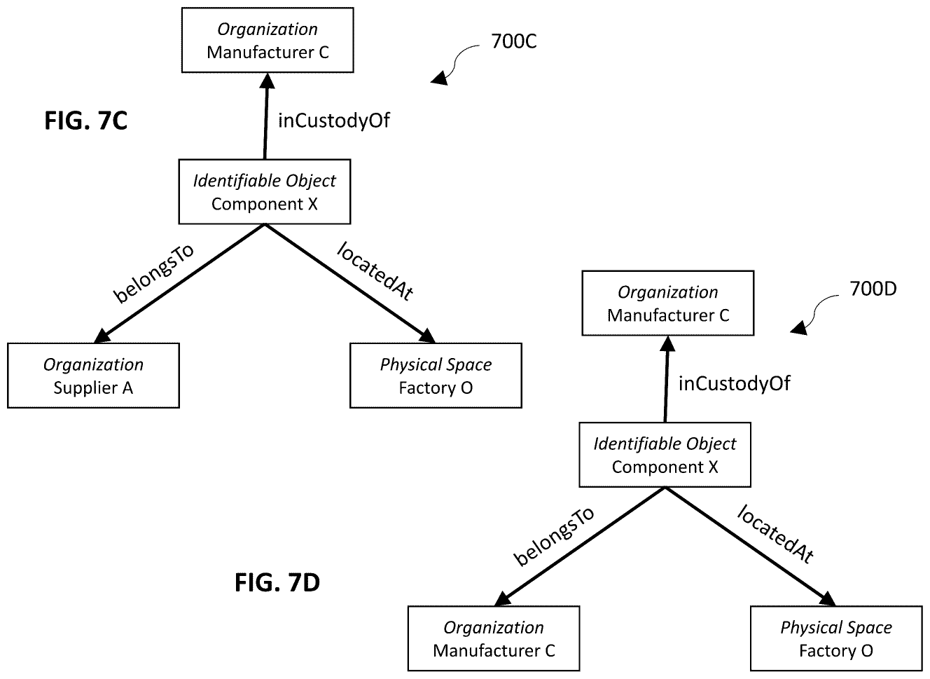

FIG. 7A shows an illustrative relationship chart 700A, in accordance with some embodiments. In this example, the relationship chart 700A includes a plurality of entities, each of which may have a data collection as described herein (e.g., in connection with FIG. 1A).

In some embodiments, different types of entities may be present in a data management system. For instance, in the example of FIG. 7A, the relationship chart 700A shows three types of entities, namely, Identifiable Object (e.g., Component X), Organization (e.g., Supplier A), and Physical Space (e.g., Warehouse M). However, it should be appreciated that aspects of the present disclosure are not limited to any particular entity type, or to classifying entities into different types.

In some embodiments, a data collection of an entity may be maintained using one or more knowledge structures in a standardized format, such as an RDF format. For instance, the illustrative Component X shown in FIG. 7A may have an identity node, which may be similar to the illustrative Identity node 205 shown in FIG. 2A. Below is an illustrative RDF implementation of a knowledge structure corresponding to the Component X's identity node, in accordance with some embodiments.

```
# Component X
<https://example.org/entity#component-X>
  rdf:ID  “71b1b0c8-a508-4eab-aec2-22759d6e2fef” ;
  rdf:type  ont:Identity ;
  ont:creationDate  “2019-03-22T00:00:00+00:00” ;
  # Identity access key
  ont:hasAsymmetricKey  <https://example.org/crypto#
af01aaa0-2e38-4574-ba64-620ecc390584> ;
  # Signer key (private state)
  ont:hasAsymmetricKey  <https://example.org/crypto#
c336d17b-f2e9-44aa-898a-3aa225c08c00> ;
  # Custodian attribute
  ont:hasAttribute  <https://example.org/attributes#
08814de3-c654-425b-9a132-57274f4fe97> ;
  # Owner attribute
  ont:hasAttribute  <https://example.org/attributes#
64c8dd27-4865-4d09-8029-ca8365dac78c> ;
  # Location attribute
  ont:hasAttribute  <https://example.org/attributes#
b22fb5c5-c7a6-451b-b0a9-18eea7d6dc9e> ;
  # Authorization sub-graph that authorizes Supplier A
  ont:hasAuthorization  <https://example.org/authorizations#
4708f58a-5c90-4420-86d9-8e79bbe54cf3> .
```

In the example of FIG. 7A, the Component X has an inCustodyOf attribute, a belongsTo attribute, and a locatedAt attribute. The Component X's identity node may store references to knowledge structures corresponding, respectively, to these attributes. The knowledge structure corresponding to the inCustodyOf attribute may store a reference to an identity node of the illustrative Supplier A shown in FIG. 7A, indicating that the Component X is in custody of the Supplier A. The knowledge structure corresponding to the belongsTo attribute may also store the reference to the identity node of the Supplier A, indicating that the Component X is owned by the Supplier A. The knowledge structure corresponding to the locatedAt attribute may store a reference to an identity node of the illustrative Warehouse M shown in FIG. 7A, indicating that the Component X is located at the Warehouse M.

Below is an illustrative RDF implementation of a knowledge structure corresponding to the Supplier A's identity node, in accordance with some embodiments. Although not shown below, the Supplier A may, in some embodiments, have one or more attributes and/or one or more badges.

```
# Supplier A
<https://example.org/entity#supplier-A>
  rdf:ID  “014240c5-c313-4fca-9dcf-9d88dc3769ca” ;
  rdf:type  ont:Identity ;
  ont:creationDate  “2019-03-21T00:00:00+00:00” ;
  # Identity access key
  ont:hasAsymmetricKey  <https://example.org/crypto#
b9470db6-bc54-4a5a-87dc-7e28d085bb03> ;
  # Signer key (private state)
  ont:hasAsymmetricKey  <https://example.org/crypto#
3ab757e4-4e98-11e9-8647-d663bd873d93> .
```

Below are illustrative RDF implementations of an inCustodyOf attribute, a belongsTo attribute, and a locatedAt attribute associated with the Component X, in accordance with some embodiments.

```
# Custodian associated with Component X (private state)
<https://example.org/attributes#08814de3-c654-425b-a132-957274f4fe97>
  rdf:type  ont:Attribute ;
  ont:hasLatest  <https://example.org/attribute-version#34cf4df4-daf4-
466a-b990-ed51fc1727bd> ;
  ont:hasPrevious  ( ) .
<https://example.org/attribute-version#34cf4df4-daf4-466a-b990-
ed51fc1727bd>
  rdf:type  ont:InCustodyOf ;
  ont:version  1 ;
  ont:creationDate  “2019-03-22T00:00:00+00:00” ;
  rdf:value  <https://example.org/entity#supplier-A> ;
  ont:hasAttestation  <https://example.org/attestations#f626e2e5-fe0a-42e5-
b669-6299f72a509b> .
# Owner associated with Component X (private state)
<https://example.org/attributes#64c8dd27-4865-4d09-8029-ca8365dac78c>
  rdf:type  ont:Attribute ;
  ont:hasLatest  <https://example.org/attribute-version#848cde74-6f94-
470c-9b01-9c5e41cbbc84> ;
  ont:hasPrevious  ( ) .
<https://example.org/attribute-version#848cde74-6f94-470c-9b01-
9c5e41cbbc84>
  rdf:type  ont:BelongsTo ;
  ont:version  1 ;
  ont:creationDate  “2019-03-22T00:00:00+00:00” ;
  rdf:value  <https://example.org/entity#supplier-A> ;
  ont:hasAttestation  <https://example.org/attestations#56e11994-a0ff-4dc5-
b707-c44aa82bb896> .
# Location associated with Component X (private state)
<https://example.org/attributes#b22fb5c5-c7a6-451b-b0a9-18eea7d6dc9e>
  rdf:type  ont:Attribute ;
  ont:hasLatest  <https://example.org/attribute-version#f7168e7a-c491-
45e8-bd98-a7221114b3e0> ;
  ont:hasPrevious  ( ) .
<https://example.org/attribute-version#f7168e7a-c491-45e8-bd98-
a7221114b3e0>
  rdf:type  ont:LocatedAt ;
  ont:version  1 ;
  ont:creationDate  “2019-03-22T00:00:00+00:00” ;
  rdf:value  <https://example.org/entity#warehouse-M> ;
  ont:hasAttestation  <https://example.org/attestations#d9606041-1c58-
444f-8093-6ble95317efe> .
```

In some embodiments, a knowledge structure for an attribute may store a reference to a latest version of the attribute (which may be stored in an ont: hasLatest property), and zero or more references to previous versions of the attribute (which may be stored in an ont: hasPrevious property). Each version may be associated with a version number. However, it should be appreciated that aspects of the present disclosure are not limited to any particular way of maintaining versions of an attribute, or to any versioning at all. In some embodiments, each version (except an initial version) may have a pointer to a previous version, thereby forming a linked list of versions.

In some embodiments, attribute values such as the Component X's custodian, owner, and location may be treated as sensitive data, and may be shared with other entities selectively. Accordingly, in the above example, the knowledge structures for the inCustodyOf attribute, the belongsTo attribute, and the locatedAt attribute, including the attribute versions, are shown in bold, to indicate that the knowledge structures may be in a private state of the Component X.

Referring again to the example above, each attribute version has a reference to an associated attestation. Below are illustrative RDF implementations of an attestation structure for version 1 of the inCustodyOf attribute, as well as an associated signature structure, in accordance with some embodiments.

```
# Component X - custodian attestation (private state)
<https://example.org/attestations#f626e2e5-fe0a-42e5-b669-6299f72a509b>
  rdf:type  ont:AttributeAttestation ;
  ont:salt
“838c3aae73d24272bd81df3d8c31983b838c3aae73d24272bd81df3d8c31983b
cdd3c628216c4962add47a0696d26273” ;
  # Salted hash of identity, attribute, and/or attribute version sub-graphs
(e.g., <https://example.org/attribute-version#34cf4df4-daf4-466a-b990-
ed51fc1727bd>), and/or references thereto and/or properties therein
  ont:proof
“f1884da92f2b44f3abadb984467669c846048e3284484022be2cb9c0e96a98695
d728151d70443929eec3518bd04541a” ;
  ont:proofAlgo  “HMAC_SHA384” ;
  ont:creationDate  “2019-03-22T00:00:00+00:00” ;
  ont:expirationDate  “2020-03-22T00:00:00+00:00” ;
  ont:hasSignature  <https://example.org/signatures#fcc28e0e-3983-444b-
89dd-ecc8f0fd7b59> .
<https://example.org/signatures#fcc28e0e-3983-444b-89dd-ecc8f0fd7b59>
  rdf:type  ont:Signature ;
  # Supplier A's signer key
  ont:hasSigner  <https://example.org/crypto#3ab757e4-4e98-11e9-
8647-d663bd873d93> ;
```

| | |
|---|---|
| ont:creationDate | “2019-03-22T00:00:00+00:00” ; |

```
  # Signature of attestation sub-graph along with public portion of Supplier
A's signer key sub-graph
  ont:signature
“3d9077b0fc814fa792f7cb0a5f1f9321463be777f51d4a55be4d0fa07823cfe7f88
a82becf16441eb4d55e8180676ae8e60942544cce46d2a9dee99dff94e1656d” .
```

In this example, the attestation structure for version 1 of the inCustodyOf attribute, as well as the associated signature structure, are shown in bold, to indicate that these knowledge structures may be in a private state of the Component X. The attestation structure may store a cryptographic proof of a value of version 1 of the inCustodyOf attribute (e.g., the pointer to the identity node of the Supplier A). The cryptographic proof may be generated based on one or more data structures, including, but not limited to, the Component X's identity node (e.g., <https://example.org/entity #component-X>), the inCustodyOf attribute (e.g., <https://example.org/attributes #08814de3-c654-425b-a132-957274f4fe97>), version 1 of the inCustodyOf attribute (e.g., <https://example.org/attribute-version #34cf4df4-daf4-466a-b990-ed51fc1727bd>), references to these sub-graphs, and/or properties in these sub-graphs (e.g., ont: creationDate, ont: hasAsymmetricKey, etc.).

Additionally, or alternatively, the attestation structure may store information indicating how the cryptographic proof was generated. For instance, the attestation structure may store an indication of an algorithm and a salt used to generate the cryptographic proof. In some embodiments, the salt may be a random value that was combined with the one or more data structures prior to applying the algorithm to generate the cryptographic proof.

In some embodiments, the attestation structure for version 1 of the inCustodyOf attribute may be signed by the Supplier A, indicating the Supplier A has confirmed that the Component X is indeed in custody of the Supplier A. For instance, in the above example, the attestation structure for version 1 of the inCustodyOf attribute stores a reference to the associated signature structure, which may store a signature. In some embodiments, the signature may be generated using a cryptographic key associated with the Supplier A. A reference to this cryptographic key may be stored in the associated signature structure (e.g., in an ont: hasSigner property). The signature may be generated over the attestation structure for version 1 of the inCustodyOf attribute, along with a public portion of a sub-graph of the cryptographic key associated with the Supplier A. For instance, the signature may be generated over the attestation structure and a public key associated with the Supplier A, but not the corresponding private key.

In some embodiments, an attestation structure for version 1 of the belongsTo attribute may be provided that is similar to the above attestation structure, and likewise for version 1 of the locatedAt attribute.

Although examples of relationship attributes (e.g., inCustodyOf, belongsTo, locatedAt, etc.) are described herein, it should be appreciated that aspects of the present disclosure are not limited to using any particular relationship attribute, or any relationship attribute at all.

In some embodiments, the knowledge structure corresponding to the Component X's identity node may store a reference to an authorization structure, which may indicate how the Component X's identity node may be modified. Below is an illustrative RDF implementation of an authorization structure, in accordance with some embodiments.

```
# Authorization structure that authorizes Supplier A (private state)
<https://example.org/authorizations#4708f58a-5c90-4420-86d9-
8e79bbe54cf3>
  rdf:type  ont:Authorization ;
  ont:creationDate  “2019-03-22T00:00:00+00:00” ;
  # Supplier A's signer key
  ont:hasAsymmetricKey <https://example.org/crypto#3ab757e4-
4e98-11e9-8647-d663bd873d93> ;
  ont:canUpdate  [ ont:hasAsymmetricKey,
ont:hasAttribute, ont:hasBadge, ont:hasAuthorization ] ;
  ont:canCreate  [ ont:hasAsymmetricKey,
ont:hasAttribute, ont:hasBadge, ont:hasAuthorization ] ;
  ont:canDelete  [ ont:hasAsymmetricKey,
ont:hasAttribute, ont:hasBadge, ont:hasAuthorization ] .
```

In this example, the authorization structure stores a reference to a cryptographic key associated with the Supplier A (e.g., in an ont: hasAsymmetricKey property). This may indicate that an entity having that cryptographic key may be allowed to modify the Component X's identity node in one or more ways. For instance, an entity having that cryptographic key may be allowed to update one or more properties indicated in an ont: canUpdate property (e.g., ont: hasAsymmetricKey, ont: hasAttribute, ont: hasBadge, ont: hasAuthorization, etc.), create one or more properties indicated in an ont: canCreate property (e.g., ont: hasAsymmetricKey, ont: hasAttribute, ont: hasBadge, ont: hasAuthorization, etc.), and/or delete one or more properties indicated in an ont: canUpdate property (e.g., ont: hasAsymmetricKey, ont: hasAttribute, ont: hasBadge, ont: hasAuthorization, etc.).

Although certain details of implementation are described above in connection with FIG. 7A, it should be appreciated that such details are provided solely for purposes of illustration. The techniques introduced above and/or discussed in detail below are not limited to any particular manner of implementation.

FIG. 7B shows another illustrative relationship chart 700B, in accordance with some embodiments. The relationship chart 700B may be similar to the illustrative relationship chart 700A in the example of FIG. 7A, except an inCustodyOf attribute of the Component X may refer to a Carrier B (instead of the Supplier A), and a locatedAt attribute of the Component X may refer to a Container N (instead of the Warehouse M). In some embodiments, these changes may reflect the Supplier A hiring the Carrier B to transport the Component X, and the Carrier B loading the Component X from the Warehouse M into the Container N.

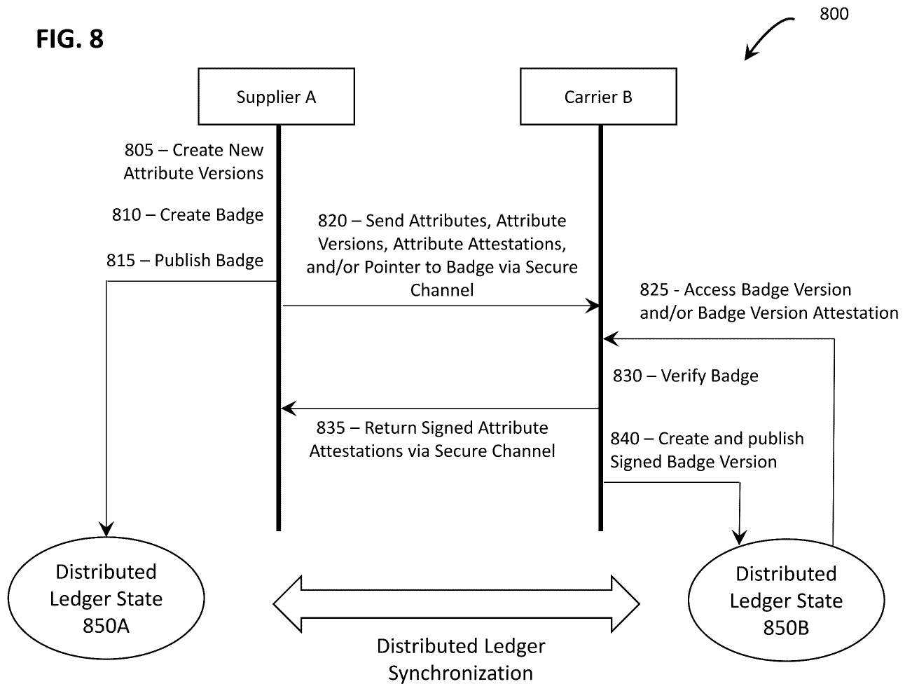

FIG. 8 shows an illustrative process 800 for a custody transfer and/or a location change, in accordance with some embodiments. For instance, the process 800 may be performed between the Supplier A and the Carrier B in the example of FIGS. 7A-B to evidence a custody transfer and/or a location change of the Component X.

In some embodiments, when the Carrier B arrives at the Warehouse M to pick up a shipment including the Component X, the Supplier A may, at act 805, create a new version of the inCustodyOf attribute and a new version of the locatedAt attribute. The new version of the inCustodyOf attribute may store a reference to the Carrier B, because the Supplier A is transferring custody of the Component X to the Carrier B. The new version of the locatedAt attribute may store a reference to the Container N, because the Component X is being removed from the Warehouse M and placed into the Container N.

Below are illustrative RDF implementations of a new version of the inCustodyOf attribute and a new version of the locatedAt attribute, in accordance with some embodiments.

| # New custodian attribute version (private state) | |
|---|---|
| <https://example.org/attribute-version#10516997-1768-4344- | |
| 8ceb-619145ce680f> | |
| rdf:type | ont:InCustodyOf ; |
| rdf:version | 2 ; |
| ont:creationDate | “2019-03-26T00:00:00+00:00” ; |
| rdf:value | <https://example.org/entity#carrier-B> ; |
| ont:hasAttestation | |
| <https://example.org/attestations#1705e002-59bb-47ff-9fa8- | |
| 6dcb419df1c5> . | |
| # New location attribute version (private state) | |
| <https://example.org/attribute-version#ff3686d6-c074-4990- | |
| b146-44253e17711a> | |
| rdf:type | ont:LocatedAt ; |
| rdf:version | 2 ; |
| ont:creationDate | “2019-03-26T00:00:00+00:00” ; |
| rdf:value | <https://example.org/entity#container- |

N> ;
ont:hasAttestation
<https://example.org/attestations#6228ed20-36d7-416c-a88d-
302b53f49ebc> .

In this example, each of the new versions of the inCustodyOf attribute and the locatedAt attribute has a reference to an associated attestation. Below is an illustrative RDF implementation of an attestation structure for version 2 of the inCustodyOf attribute, in accordance with some embodiments.

# New custodian attribute version attestation (private state)
<https://example.org/attestations#1705e002-59bb-47ff-9fa8-
6dcb419df1c5>

| | |
|---|---|
| rdf:type | ont:AttributeAttestation ; |

```
  ont:salt
“7da61a9d8ab1475fbaa8cfed62f491e6829317e1347e40eeb61e742de4dfb
da999eacaa17e5e4ea192dc549173f02134” ;
  # Salted hash of identity, attribute, and/or attribute
version sub-graphs (e.g., <https://example.org/attribute-
version#10516997-1768-4344-8ceb-619145ce680f>), and/or
references thereto and/or properties therein
  ont:proof
“83893c3e9b524d35a97d75bcbe196035e8b645c79ad146a48414e9f66209d
5f4e1bd8708a6a04781bf196c804d85a793” ;
```

| | |
|---|---|
| ont:proofAlgo | “HMAC_SHA384” ; |
| ont:creationDate | “2019-03-26T00:00:00+00:00” ; |
| ont:expirationDate | “2020-03-26T00:00:00+00:00” ; |

ont:hasSignature
<https://example.org/signatures#f4785ede-bb6f-44cc-b700-
b89d311cb5ee> .
<https://example.org/signatures#f4785ede-bb6f-44cc-b700-
b89d311cb5ee>

| | |
|---|---|
| rdf:type | ont:Signature ; |

```
  # Carrier B's signer key
  ont:hasSigner
<https://example.org/crypto#7834b0e6-2cd3-40ad-b303-
b892efae54dc> .
```

In this example, the attestation structure for version 2 of the inCustodyOf attribute stores a cryptographic proof, an indication of an algorithm, and a salt that was combined with one or more data structures prior to applying the algorithm to generate the cryptographic proof. Examples of data structures used to generate the cryptographic proof include, but are not limited to, the Component X's identity node (e.g., <https://example.org/entity #component-X>), the inCustodyOf attribute (e.g., <https://example.org/attributes #08814de3-c654-425b-a132-957274f4fe97>), version 2 of the inCustodyOf attribute (e.g., <https://example.org/attribute-version #10516997-1768-4344-8ceb-619145ce680f>), references to these sub-graphs, and/or properties in these sub-graphs (e.g., ont: creationDate, ont: hasAsymmetricKey, etc.).

In some embodiments, the cryptographic proof may be generated by the Supplier A (e.g., when version 2 of the inCustodyOf attribute is created). However, it should be appreciated that aspects of the present disclosure are not so limited. For instance, the inventors have recognized and appreciated that having the Carrier B generate the cryptographic proof may provide stronger evidence that the Carrier B has examined version 2 of the inCustodyOf attribute. Accordingly, in some embodiments, the ont: proof property may be omitted in the above attestation structure, and may be inserted by the Carrier B at a later time.

In some embodiments, the attestation structure for version 2 of the inCustodyOf attribute may store a reference to an associated signature structure. Since version 2 of the inCustodyOf attribute and the associated attestation structure are still pending verification by the Carrier B, the signature structure may not include any signature yet.

In some embodiments, an attestation structure for version 2 of the locatedAt attribute may be provided that is similar to the above attestation structure for version 2 of the inCustodyOf attribute.

In some embodiments, the Supplier A may update the inCustodyOf attribute and the locatedAt attribute of the Component X to include the newly created versions of the attributes. Below are illustrative RDF implementations of an updated inCustodyOf attribute and an updated locatedAt attribute, in accordance with some embodiments.

| # Updated custodian attribute (private state) | |
|---|---|
| <https://example.org/attributes#08814de3-c654-425b-a132- | |
| 957274f4fe97> | |
| rdf:type | ont:Attribute ; |
| ont:hasLatest | <https://example.org/attribute- |
| version#10516997-1768-4344-8ceb-619145ce680f> ; | |
| ont:hasPrevious | ( <https://example.org/attribute- |
| version#34cf4df4-daf4-466a-b990-ed51fc1727bd> ) ; | |
| ont:hasAuthorization | |
| <https://example.org/authorizations#9ce0b926-376f-450b-8386- | |
| 339264de08cf> . | |
| # Updated location attribute (private state) | |
| <https://example.org/attributes#b22fb5c5-c7a6-451b-b0a9- | |
| 18eea7d6dc9e> | |
| rdf:type | ont:Attribute ; |
| ont:hasLatest | <https://example.org/attribute- |
| version#ff3686d6-c074-4990-b146-44253e17711a> ; | |
| ont:hasPrevious | ( <https://example.org/attribute- |

version#f7168e7a-c491-45e8-bd98-a7221114b3e0> ) ;
ont:hasAuthorization
<https://example.org/authorizations#9ce0b926-376f-450b-8386-
339264de08cf> .

In some embodiments, the updated inCustodyOf attribute and the updated locatedAt attribute may each store a reference to an authorization structure, which may indicate how the attribute structures may be modified. Below is an illustrative RDF implementation of an authorization structure for the updated inCustodyOf attribute and the updated locatedAt attribute, in accordance with some embodiments.

| # Authorization structure for new custodian (private state) | |
|---|---|
| <https://example.org/authorizations#9ce0b926-376f-450b-8386- | |
| 339264de08cf> | |
| rdf:type | ont:Authorization ; |
| ont:creationDate | “2019-03-26T00:00:00+00:00” ; |
| # Carrier B's signer key | |
| ont:hasAsymmetricKey | |
| <https://example.org/crypto#7834b0e6-2cd3-40ad-b303- | |
| b892efae54dc> ; | |
| ont:canUpdate | [ ont:hasLatest, ont:hasPrevious, |

ont:hasAuthorization ] .

In this example, the authorization structure stores a reference to a cryptographic key associated with the Carrier B (e.g., in an ont: hasAsymmetricKey property). This may indicate that an entity having that cryptographic key may be authorized in one or more ways. For instance, an entity having that cryptographic key may be allowed to update one or more properties indicated in an ont: canUpdate property (e.g., ont: hasLatest, ont: hasPrevious, ont: hasAuthorization, etc.).

In some embodiments, a data management service may check that the Supplier A is authorized to modify one or more data structures that the Supplier A is proposing to modify in the Component X's private state (e.g., attribute, attribute version, attribute version attestation, etc.). For instance, the data management service may check whether the Supplier A is in possession of a private key of a key pair indicated in the Component X's authorization structure (e.g., <https://example.org/authorizations #4708f58a-5c90-4420-86d9-8e79bbe54cf3>), for example, by providing a fresh random value to the Supplier A, requesting that the Supplier A use the private key to sign the fresh random value, and using a public key of the key pair to verify a signature returned by the Supplier A.

Additionally, or alternatively, the data management service may check, based on the Component X's authorization structure, whether a modification proposed by the Supplier A should be allowed. For instance, the data management service may determine that the Supplier A is allowed to update the inCustodyOf attribute and the locatedAt attribute because an ont: canUpdate property in the Component X's authorization structure indicates that the Supplier A is authorized to update the Component X's attributes and sub-graphs thereof.

In the above example, the Carrier B is authorized to update the property ont: hasAuthorization so that the Carrier B may be able to transfer custody (e.g., to another carrier) and/or change location (e.g., to another shipping container). However, the inventors have recognized and appreciated that it may be desirable to have an owner of the Component X (e.g., the Supplier A) approve such changes. Accordingly, in some embodiments, the authorization structure may store references to multiple cryptographic key pairs (e.g., the Carrier B's signer key pair and the Supplier A's signer key pair). A threshold cryptography scheme with a suitable threshold N (e.g., N=2) may be used, so that a transaction for custody transfer or location change may not be recorded until the transaction is approved by holders of at least N cryptographic keys.

Returning to the example of FIG. 8, the Supplier A may, at act 810, create a badge for use in evidencing a custody transfer and/or a location change of the Component X. Below is an illustrative RDF implementation of a badge associated with the Component X, in accordance with some embodiments.

| # Component X's badge for custody transfer to Carrier B | |
|---|---|
| <https://example.org/badges#d6e005c2-d974-4e1f-8ab3- | |
| 449e950d8167> | |
| rdf:type | ont:Badge ; |
| ont:hasLatest | <https://example.org/badge- |
| version#9094eb7b-a2f5-48a9-8712-8728b37b6c87> ; | |
| ont:hasPrevious | ( ) ; |

ont:hasAuthorization
<https://example.org/authorizations#337a9f6e-33e0-4a9b-b90d-
582b2318692c> .

In this example, the badge associated with the Component X includes a reference to a latest version of the badge (which may be stored in an ont: hasLatest property), and zero or more references to previous versions of the badge (which may be stored in an ont: hasPrevious property). When the badge is newly created by the Supplier A, there may be no previous version.

In some embodiments, the badge may include a reference to an authorization structure, which may indicate how the badge may be modified. Below is an illustrative RDF implementation of an authorization structure for the badge, in accordance with some embodiments.

| # Authorization structure for Component X's badge | |
|---|---|
| <https://example.org/authorizations#337a9f6e-33e0-4a9b-b90d- | |
| 582b2318692c> | |
| rdf:type | ont:Authorization ; |
| ont:creationDate | “2019-03-26T00:00:00+00:00” ; |
| # Carrier B's signer key | |
| ont:hasAsymmetricKey | |
| <https://example.org/crypto#7834b0e6-2cd3-40ad-b303- | |
| b892efae54dc> ; | |
| ont:canUpdate | [ ont:hasLatest, ont:hasPrevious ] . |

In some embodiments, the authorization structure may store a reference to a cryptographic key associated with the Carrier B (e.g., in an ont: hasAsymmetricKey property). This may indicate that an entity having that cryptographic key may be allowed to modify the badge in one or more ways. For instance, an entity having that cryptographic key may be allowed to update one or more properties indicated in an ont: canUpdate property (e.g., ont: hasLatest, ont: hasPrevious, etc.).

Below is an illustrative RDF implementation of an initial version of the badge associated with the component X, in accordance with some embodiments.

| # Badge version 1 - published by Supplier A | |
|---|---|
| <https://example.org/badge-version#9094eb7b-a2f5-48a9-8712- | |
| 8728b37b6c87> | |
| rdf:type | ont:BadgeVersion ; |
| ont:version | 1 ; |
| ont:creationDate | “2019-03-26T00:00:00+00:00” ; |
| ont:hasAttribute | |
| <https://example.org/attribute-version#10516997-1768-4344- | |
| 8ceb-619145ce680f> , | |
| <https://example.org/attribute-version#ff3686d6-c074-4990- | |
| b146-44253e17711a> ; | |
| ont:state | “PENDING” ; |

ont:hasAttestation
<https://example.org/attestations#56d66e3b-4caa-493b-9c51-
270af83501f4> .

In this example, the initial badge version includes a reference to version 2 of the inCustodyOf attribute and a reference to version 2 of the locatedAt attribute. As discussed above, version 2 of the inCustodyOf attribute may reference the Carrier B, while version 2 of the locatedAt attribute may reference the Container N. In some embodiments, the Supplier A may request that the Carrier B attest to the badge, so as to evidence the custody transfer to the Carrier B and the location change to the Container N.

In some embodiments, the initial badge version may store a label (e.g., “PENDING”) indicating that the badge is pending verification by the Carrier B.

In some embodiments, the Supplier A may create an attestation structure for the initial badge version. An attestation structure for a badge version may be similar to an attestation structure for an attribute. However, a cryptographic proof stored in a badge version attestation structure may be generated differently. Below is an illustrative RDF implementation of an attestation structure for the initial badge version, in accordance with some embodiments.

# Badge version 1 attestation
<https://example.org/attestations#56d66e3b-4caa-493b-9c51-
270af83501f4>

| | |
|---|---|
| rdf:type | ont:BadgeAttestation ; |

```
  ont:salt
“b2a6f2155988495ca40a1e5048d730cd35e145ea093642408e06ad9c7737a
d7eaac39ff2b9c949b1b7615b9365361046” ;
  # Salted hash of identity, badge, badge version,
attribute, attribute version, and/or attribute version
attestation sub-graphs, and/or references thereto and/or
properties therein
  ont:proof
“3dc9fd6e525240a6802e5e0af14ea9fea804d84e534d4ac6a023cf975e484
c6523e73ebfb302441b8e2fbfe28013672d” ;
```

| | |
|---|---|
| ont:proofAlgo | “HMAC_SHA384” ; |
| ont:creationDate | “2019-03-26T00:00:00+00:00” ; |
| ont:expirationDate | “2020-03-26T00:00:00+00:00” ; |

ont:hasSignature
<https://example.org/signatures#fb9f7cc1-83cb-471e-a517-
03f832fcb4e4> .
<https://example.org/signatures#fb9f7cc1-83cb-471e-a517-
03f832fcb4e4>

| | |
|---|---|
| rdf:type | ont:Signature ; |

```
  # Supplier A's signer key
  ont:hasSigner
<https://example.org/crypto#3ab757e4-4e98-11e9-8647-
d663bd873d93> ;
```

| | |
|---|---|
| ont:creationDate | “2019-03-26T00:00:00+00:00” ; |

```
  # Signature of attestation sub-graph along with public
portion of Supplier A's signer key sub-graph
  ont:signature
“0912e48577914a84969061e0fa26f8768a43423eb14d42ef8faac4e54b96e
067094aad5036eb4cfba63f982ef38336e1” .
```

In the above example, the attestation structure for the initial badge version stores a cryptographic proof, an indication of an algorithm, and a salt that was combined with one or more data structures prior to applying the algorithm to generate the cryptographic proof. Examples of data structures used to generate the cryptographic proof include, but are not limited to, the Component X's identity node (e.g., <https://example.org/entity #component-X>), the inCustodyOf attribute (e.g., <https://example.org/attributes #08814de3-c654-425b-a132-957274f4fe97>), version 2 of the inCustodyOf attribute (e.g., <https://example.org/attribute-version #10516997-1768-4344-8ceb-619145ce680f>), the attestation structure for version 2 of the inCustodyOf attribute (e.g., <https://example.org/attestations #1705e002-59bb-47ff-9fa8-6dcb419df1c5>), the locatedAt attribute (e.g., <https://example.org/attributes #b22fb5c5-c7a6-451b-b0a9-18eea7d6dc9e>), version 2 of the locatedAt attribute (e.g., <https://example.org/attribute-version #ff3686d6-c074-4990-b146-44253e17711a>), the attestation structure for version 2 of the locatedAt attribute (e.g., <https://example.org/attestations #6228ed20-36d7-416c-a88d-302b53f49ebc>), the badge (e.g., <https://example.org/badges #d6e005c2-d974-4e1f-8ab3-449e950d8167>), the initial badge version (e.g., <https://example.org/badge-version #9094eb7b-a2f5-48a9-8712-8728b37b6c87>), the attestation structure for the initial badge version (e.g., <https://example.org/attestations #56d66e3b-4caa-493b-9c51-270af83501f4>), references to these sub-graphs, and/or properties in these sub-graphs (e.g., ont: hasAsymmetricKey, ont: salt, ont: proofAlgo, ont: creationDate, ont: expirationDate, etc.).

In some embodiments, the attestation structure for the initial badge version may store a reference to an associated signature structure, which may store a signature. In some embodiments, the signature may be generated using a cryptographic key associated with the Supplier A. A reference to this cryptographic key may be stored in the associated signature structure (e.g., in an ont: hasSigner property). The signature may be generated over the attestation structure for the initial badge version, along with a public portion of a sub-graph of the cryptographic key associated with the Supplier A. For instance, the signature may be generated over the attestation structure and a public key associated with the Supplier A, but not the corresponding private key.

In some embodiments, the badge, the initial badge version, and the attestation structure associated with the initial badge version may be part of a public state of the Component X, whereas the inCustodyOf and locatedAt attributes and the associated attribute versions and attestation structures may be part of a private state of the Component X. However, that is not required. For instance, in some embodiments, attribute version attestations may be part of the public state, in addition to, or instead of badge version attestations.

In some embodiments, the Supplier A may update the identity node of the Component X to include the newly created badge. Below is an illustrative RDF implementation of an updated identity node, in accordance with some embodiments.

# Component X with newly created badge
<https://example.org/entity#component-X>

| | |
|---|---|
| rdf:ID | “71b1b0c8-a508-4eab-aec2- |

22759d6e2fef” ;

| | |
|---|---|
| rdf:type | ont:Identity ; |
| ont:creationDate | “2019-03-22T00:00:00+00:00” ; |

# Identity access key

| | |
|---|---|
| ont:hasAsymmetricKey | <https://example.org/crypto# |

af01aaa0-2e38-4574-ba64-620ecc390584> ;
# Signer key (private state)

| | |
|---|---|
| ont:hasAsymmetricKey | <https://example.org/crypto# |

```
c336d17b-f2e9-44aa-898a-3aa225c08c00> ;
  # Custodian attribute
  ont:hasAttribute
<https://example.org/attributes#08814de3-c654-425b-a132-
957274f4fe97> ;
  # Owner attribute
  ont:hasAttribute
<https://example.org/attributes#64c8dd27-4865-4d09-8029-
ca8365dac78c> ;
  # Location attribute
  ont:hasAttribute
<https://example.org/attributes#b22fb5c5-c7a6-451b-b0a9-
18eea7d6dc9e> ;
  # Authorization sub-graph that authorizes Supplier A
  ont:hasAuthorization
<https://example.org/authorizations#4708f58a-5c90-4420-86d9-
8e79bbe54cf3> ;
  # Authorization sub-graph that authorizes Carrier B
  ont:hasAuthorization
<https://example.org/authorizations#ea60e376-5724-4c00-a539-
73acaf23b532> ;
  # Newly created badge
```

| | |
|---|---|
| Ont:hasBadge | <https://example.org/badges#d6e005c2- |

d974-4e1f-8ab3-449e950d8167> .

Additionally, or alternatively, the Supplier A may add, to the Component X's identity node, a reference to a new authorization structure that authorizes the Carrier B to create new badges. Below is an illustrative RDF implementation of such an authorization structure, in accordance with some embodiments.

| # Authorization structure that authorizes Carrier B (private | |
|---|---|
| state) | |
| <https://example.org/authorizations#ea60e376-5724-4c00-a539- | |
| 73acaf23b532> | |
| rdf:type | ont:Authorization ; |
| ont:creationDate | “2019-03-26T00:00:00+00:00” ; |
| # Carrier B's signer key | |
| ont:hasAsymmetricKey | |
| <https://example.org/crypto#7834b0e6-2cd3-40ad-b303- | |
| b892efae54dc> ; | |
| ont:canCreate | [ ont:hasBadge ] . |

Returning to the example of FIG. 8, the Supplier A may, at act 815, publish the badge to a distributed ledger (e.g., the illustrative distributed ledger described above in connection with FIG. 1A). In some embodiments, a distributed ledger state maintained by the Supplier A (e.g., distributed ledger state 850A in the example of FIG. 8) may be part of the Supplier A's data collection, without being duplicated as an additional data collection. Accordingly, the Supplier A may publish the badge by invoking a distributed ledger client to propagate the Supplier A's public state (which may already include the badge, the initial badge version, and the attestation structure associated with the initial badge version) to one or more other network nodes maintaining the distributed ledger. As a result, a network node operated by the Carrier B may synchronize the Carrier B's public state (e.g., distributed ledger state 850B) to include the initial badge version and the associated attestation structure generated by the Supplier A.

In some embodiments, the distributed ledger client may check whether the Supplier A is authorized to make changes to the Component X's state. For instance, the distributed ledger client may use a reference stored in the Component X's identity node to access an authorization structure (e.g., <https://example.org/authorizations #4708f58a-5c90-4420-86d9-8e79bbe54cf3>). The distributed ledger client may check that the Supplier A is in possession of a private key of a key pair indicated in the authorization structure (e.g., <https://example.org/crypto #3ab757e4-4e98-11e9-8647-d663bd873d93>), for example, by checking the signature in the signature structure associated with the initial badge version.

Additionally, or alternatively, the distributed ledger client may check, based on the Component X's authorization structure, whether a modification proposed by the Supplier A should be allowed. For instance, the distributed ledger client may determine that the Supplier A is allowed to create a badge and associated sub-graphs (e.g., badge version, badge version attestation, etc.) because an ont: canCreate property in the Component X's authorization structure indicates that the Supplier A is authorized to create new badges and sub-graphs thereof.

In some embodiments, one or more of the checks described above may be performed by a data management service in addition to, or instead of, the distributed ledger client. Additionally, or alternatively, the data management service may check, based on a current version of the Component X's authorization structure, whether the Supplier A should be allowed to update the authorization structure. For instance, the data management service may determine that the Supplier A is allowed to do so because an ont: canUpdate property in the Component X's authorization structure indicates that the Supplier A is authorized to update the authorization structure itself.

Returning to the example of FIG. 8, the Supplier A may, at act 820, send a request to the Carrier B via a secure channel (e.g., with end-to-end encryption). For instance, the Supplier A may send a pointer to the badge (e.g., <https://example.org/badges #d6e005c2-d974-4elf-8ab3-449e950d8167>), and may request that the Carrier B verify and sign the badge. In response, the Carrier B may, at act 825, use the pointer to access the badge from the distributed ledger state 850B, which may in turn allow the Carrier B to access the initial badge version and the associated attestation structure from the distributed ledger state 850B.

In some embodiments, the Supplier A may make version 2 of the inCustodyOf attribute and version 2 of the locatedAt attribute and the associated attestation structures available to the Carrier B in a suitable manner. For instance, the Supplier A may send version 2 of the inCustodyOf attribute and version 2 of the locatedAt attribute and the associated attestation structures to the Carrier B via the secure channel, along with the pointer to the badge.

At act 830, the Carrier B may verify the badge. In some embodiments, the Carrier B may verify that a physical object loaded from the Warehouse M into the Container N matches the Component X's identity node. For instance, the Carrier B may verify that an identifier that is physically associated with the physical object (e.g., printed, inscribed, etc. onto the physical object) matches an identifier stored in an rdf: id property of the Component X's identity node.

Additionally, or alternatively, the Carrier B may check that the initial badge version includes correct pointers to version 2 of the inCustodyOf attribute and version 2 of the locatedAt attribute (e.g., <https://example.org/attribute-version #10516997-1768-4344-8ceb-619145ce680f> and <https://example.org/attribute-version #ff3686d6-c074-4990-b146-44253e17711a>).

Additionally, or alternatively, the Carrier B may check that the received attribute structures include, respectively, correct pointers to the received attestation structures (e.g., <https://example.org/attestations #1705e002-59bb-47ff-9fa8-6dcb419df1c5> and <https://example.org/attestations #6228ed20-36d7-416c-a88d-302b53f49ebc>) and the Carrier B's signer key (e.g., <https://example.org/crypto #7834b0e6-2cd3-40ad-b303-b892efae54dc>).

Additionally, or alternatively, the Carrier B may check that the cryptographic proof in each received attestation structure (e.g., <https://example.org/attestations #1705e002-59bb-47ff-9fa8-6dcb419df1c5> and <https://example.org/attestations #6228ed20-36d7-416c-a88d-302b53f49ebc>) was indeed generated using the salt in the received attestation structure, the relevant identity, attribute, and/or attribute version sub-graphs, and/or one or more references thereto and/or one or more properties therein.

As discussed above in connection with act 805, the Supplier A may, in some embodiments, generate an attestation structure without including a cryptographic proof. In such an embodiment, the Carrier B may generate the cryptographic proof using the salt in the received attestation structure, the relevant identity, attribute, and/or attribute version sub-graphs, and/or one or more references thereto and/or one or more properties therein. The Carrier B may then insert the cryptographic proof into the corresponding attestation structure.

Additionally, or alternatively, the Carrier B may check that the cryptographic proof in the attestation structure of the initial badge version (e.g., <https://example.org/attestations #56d66e3b-4caa-493b-9c51-270af83501f4>) was indeed generated using the salt in the attestation structure, the relevant identity, badge, badge version, attribute, attribute version, and/or attribute version attestation sub-graphs, and/or one or more references thereto and/or one or more properties therein.

Additionally, or alternatively, the Carrier B may access a public key (e.g., <https://example.org/crypto #3ab757e4-4e98-11e9-8647-d663bd873d93>) indicated in the signature structure (e.g., <https://example.org/signatures #fb9f7cc1-83cb-47l-a517-03f832fcb4e4>) associated with the initial badge version to check the signature in the signature structure.

At act 835, the Carrier B may sign the attestation structure for version 2 of the inCustodyOf attribute, along with a public portion of a sub-graph of the cryptographic key associated with the Carrier B. For instance, the signature may be generated over the attestation structure and a public key associated with the Carrier B, but not the corresponding private key.

In some embodiments, the Carrier B may store the signature in the signature structure associated with the attestation structure for version 2 of the inCustodyOf attribute, along with a timestamp. For instance, the Carrier B may add an ont: signature property and an ont: creationDate property, as follows.

<https://example.org/signatures#f4785ede-bb6f-44cc-b700-
b89d311cb5ee>

| | |
|---|---|
| rdf:type | ont:Signature ; |

```
  # Carrier B's signer key
  ont:hasSigner
<https://example.org/crypto#7834b0e6-2cd3-40ad-b303-
b892efae54dc> ;
```

| | |
|---|---|
| ont:creationDate | “2019-03-27T00:00:00+00:00” ; |

ont:signature
“65c7e74821634dcd9a6257e2c56245278e5cb060f8394db4ad52d50b271e5
77a14d2de4e9dc4bf8ba266ce3e912703d” .

In some embodiments, the Carrier B may return the updated signature structure (e.g., with the ont: signature property and the ont: creationDate property) to the Supplier A via a secure channel (e.g., with end-to-end encryption). Additionally, or alternatively, if the Carrier B has inserted a cryptographic proof into the corresponding attestation structure, the attestation structure itself may also be returned to the Supplier A.

In some embodiments, a data management service of the Carrier B may check that the Carrier B is authorized to modify one or more data structures that the Carrier B is proposing to modify in the Component X's private state (e.g., the signature structure associated with the attestation structure for version 2 of the inCustodyOf attribute). For instance, the data management service may check whether the Carrier B is in possession of a private key of a key pair (e.g., <https://example.org/crypto #7834b0e6-2cd3-40ad-b303-b892efae54dc>) indicated in the authorization structure for the inCustodyOf attribute, for example, by using a public key of the key pair to verify the signature in the above signature structure.

Additionally, or alternatively, the data management service may check, based on the authorization structure for the inCustodyOf attribute, whether a modification proposed by the Carrier B should be allowed. For instance, the data management service may determine that the Carrier B is allowed to insert a signature and a creation date because: (i) an ont: canUpdate property in the authorization structure for the inCustodyOf attribute indicates that the Carrier B is authorized to update a latest version of the inCustodyOf attribute, and (ii) the signature structure that the Carrier B is seeking to modify is a sub-graph (indirectly, via the associated attestation structure) of version 2 of the inCustodyOf attribute.

In some embodiments, the Carrier B may sign the attestation structure for version 2 of the locatedAt attribute in a similar manner. The Carrier B may then return the signature structure and/or the attestation structure to the Supplier A via the secure channel.

In some embodiments, before updating the Supplier A's data collection with the signature structures and/or the attestation structures received from the Carrier B, a data management service of the Supplier A may perform one or more authorization checks similar to those described above.

At act 840, the Carrier B may create version 2 of the badge, which may be similar to version 1 of the badge, except the version number, the creationDate, the state, and/or the attestation pointer may be updated accordingly. Below is illustrative an RDF implementation of version 2 of the badge, in accordance with some embodiments.

| # Badge version 2 - signed by Carrier B | |
|---|---|
| <https://example.org/badge-version#68076179-a0a6-4a23-8476- | |
| 6aff4e6acfb4> | |
| rdf:type | ont:BadgeVersion ; |
| ont:version | 2 ; |
| ont:creationDate | “2019-03-27T00:00:00+00:00” ; |
| ont:hasAttribute | |
| <https://example.org/attributes#10516997-1768-4344-8ceb- | |
| 619145ce680f> , | |
| <https://example.org/attributes#1f3686d6-c074-4990-b146- | |
| 44253e17711a> ; | |
| ont:state | “VERIFIED” ; |

ont:hasAttestation
<https://example.org/attestations#c59468e9-10fa-4f66-99f7-
6736c54e4395> .

In some embodiments, the Carrier B may create an attestation structure for version 2 of the badge. An attestation structure for a badge version may be similar to an attestation structure for an attribute. However, a cryptographic proof stored in a badge version attestation structure may be generated differently. Below is an illustrative RDF implementation of an attestation structure for version 2 of the badge, in accordance with some embodiments.

```
# Badge version 2 attestation
<https://example.org/attestations#c59468e9-10fa-4f66-99f7-
6736c54e4395>
  ont:salt
“1c35cb076d6d49389d45720885cab7e8ae0b039ddd5846eb93a3cbb0812ed
cff839f3abb9ad34cea82cf96c508a93257” ;
  # Salted hash of identity, badge, badge version,
attribute, attribute version, and/or attribute version
attestation sub-graphs, and/or references thereto and/or
properties therein
  ont:proof
“0e543a7a8f0d4376afa06eb93d86cec56f63e05464f84c45999895d0f5746
a6ca2af3e89147246c1a2e45ae20fea9a13” ;
```

| | |
|---|---|
| ont:proofAlgo | “HMAC_SHA384” ; |
| ont:creationDate | “2019-03-27T00:00:00+00:00” ; |
| ont:expirationDate | “2020-03-27T00:00:00+00:00” ; |

ont:hasSignature
<https://example.org/signatures#ed81a3ba-f03e-4453-bdaf-
ade154a313a4> .
<https://example.org/signatures#ed81a3ba-f03e-4453-bdaf-
ade154a313a4>

| | |
|---|---|
| rdf:type | ont:Signature ; |

```
  # Carrier B's signer key
  ont:hasSigner
<https://example.org/crypto#7834b0e6-2cd3-40ad-b303-
b892efae54dc> ;
```

| | |
|---|---|
| ont:creationDate | “2019-03-27T00:00:00+00:00” ; |

```
  # Signature of attestation sub-graph along with public
portion of Carrier B's signer key sub-graph
  ont:signature
“15fa324baac445698046462b9158a727b825d645333741da868c7b1a50703
a14c63c4ff9fb2645bab48e0bbf9a58d95d” .
```

In the above example, the attestation structure for version 2 of the badge stores a cryptographic proof, an indication of an algorithm, and a salt that was combined with one or more data structures prior to applying the algorithm to generate the cryptographic proof. Examples of data structures used to generate the cryptographic proof include, but are not limited to, the Component X's identity node (e.g., <https://example.org/entity #component-X>), the inCustodyOf attribute (e.g., <https://example.org/attributes #08814de3-c654-425b-a132-957274f4fe97>), version 2 of the inCustodyOf attribute (e.g., <https://example.org/attribute-version #10516997-1768-4344-8ceb-619145ce680f>), the attestation structure for version 2 of the inCustodyOf attribute (e.g., <https://example.org/attestations #1705e002-59bb-47ff-9fa8-6dcb419df1c5>), the locatedAt attribute (e.g., <https://example.org/attributes #b22fb5c5-c7a6-451b-b0a9-18eea7d6dc9e>), version 2 of the locatedAt attribute (e.g., <https://example.org/attribute-version #ff3686d6-c074-4990-b146-44253e17711a>), the attestation structure for version 2 of the locatedAt attribute (e.g., <https://example.org/attestations #6228ed20-36d7-416c-a88d-302b53f49ebc>), the badge (e.g., <https://example.org/badges #d6e005c2-d974-4elf-8ab3-449e950d8167>), version 2 of the badge (e.g., <https://example.org/badge-version #68076179-a0a6-4a23-8476-6aff4e6acfb4>), the attestation structure for version 2 of the badge (e.g., <https://example.org/attestations #c59468e9-10fa-4f66-99f7-6736c54e4395>), references to these sub-graphs, and/or properties in these sub-graphs (e.g., ont: hasAsymmetricKey, ont: salt, ont: proofAlgo, ont: creationDate, ont: expirationDate, etc.).

In some embodiments, the attestation structure for version 2 of the badge may store a reference to an associated signature structure, which may store a signature. In some embodiments, the signature may be generated using a cryptographic key associated with the Carrier B. A reference to this cryptographic key may be stored in the associated signature structure (e.g., in an ont: hasSigner property). The signature may be generated over the attestation structure for version 2 of the badge, along with a public portion of a sub-graph of the cryptographic key associated with the Carrier B. For instance, the signature may be generated over the attestation structure and a public key associated with the Carrier B, but not the corresponding private key.

In some embodiments, the Carrier B may update the badge to include the newly created version 2. Below is an illustrative RDF implementation of an updated badge, in accordance with some embodiments.

| # Updated badge for custody transfer to Carrier B | |
|---|---|
| <https://example.org/badges#d6e005c2-d974-4e1f-8ab3- | |
| 449e950d8167> | |
| rdf:type | ont:Badge ; |
| ont:hasLatest | <https://example.org/badge- |
| version#68076179-a0a6-4a23-8476-6aff4e6acfb4> ; | |
| ont:hasPrevious | (<https://example.org/badge- |

version#9094eb7b-a2f5-48a9-8712-8728b37b6c87>) ;
ont:hasAuthorization
<https://example.org/authorizations#337a9f6e-33e0-4a9b-b90d-
582b2318692c> .

In some embodiments, the Carrier B may publish the updated badge to a distributed ledger (e.g., the illustrative distributed ledger described above in connection with FIG. 1A). In some embodiments, a distributed ledger state maintained by the Carrier B (e.g., distributed ledger state 850B in the example of FIG. 8) may be part of the Carrier B's data collection, without being duplicated as an additional data collection. Accordingly, the Carrier B may publish the badge by invoking a distributed ledger client to propagate the Carrier B's public state (which may already include the updated badge, version 2 of the badge, and the attestation structure associated with version 2 of the badge) to one or more other network nodes maintaining the distributed ledger.

In some embodiments, the distributed ledger client may check whether the Carrier B is authorized to make changes to the Component X's state. For instance, the distributed ledger client may use a reference stored in the badge to access an authorization structure (e.g., <https://example.org/authorizations #337a9f6e-33e0-4a9b-b90d-582b2318692c>). The distributed ledger client may check that the Carrier B is in possession of a private key of a key pair indicated in the authorization structure (e.g., <https://example.org/crypto #7834b0e6-2cd3-40ad-b303-b892efae54dc>), for example, by checking the signature in the signature structure associated with version 2 of the badge.

Additionally, or alternatively, the distributed ledger client may check, based on the authorization structure associated with the badge, whether a modification proposed by the Carrier B should be allowed. For instance, the distributed ledger client may determine that the Carrier B is allowed to update the badge and associated sub-graphs (e.g., badge version, badge version attestation, etc.) because an ont: canUpdate property in the authorization structure indicates that the Carrier B is authorized to update one or more properties in the badge (e.g., ont: hasLatest, ont: hasPrevious, etc.).

In some embodiments, one or more of the checks described above may be performed by a data management service in addition to, or instead of, the distributed ledger client.

Although certain details of implementation are described above in connection with FIG. 8, it should be appreciated that such details are provided solely for purposes of illustration. The techniques introduced above and/or discussed in detail below are not limited to any particular manner of implementation. For instance, in some embodiments, the Supplier A may not generate an attestation for the initial badge version. Instead of verifying a signature in the attestation for the initial badge version, a distributed ledge client may check whether the Supplier A is in possession of a private key of a key pair indicated in the Component X's authorization structure (e.g., <https://example.org/authorizations #4708f58a-5c90-4420-86d9-8e79bbe54cf3>), for example, by providing a fresh random value to the Supplier A, requesting that the Supplier A use the private key to sign the fresh random value, and using a public key of the key pair to verify a signature returned by the Supplier A.

Moreover, it should be appreciated that aspects of the present disclosure are not limited to using badges to organize attributes to be updated. In some embodiments, an attestation structure for an updated attribute may be published to a distributed ledger by the Supplier A, for example, with an authorization structure indicating that the Carrier B is designated for verifying the updated attribute and signing the attestation.

FIG. 7C shows another illustrative relationship chart 700C, in accordance with some embodiments. The relationship chart 700C may be similar to the illustrative relationship chart 700B in the example of FIG. 7B, except an inCustodyOf attribute of the Component X may refer to a Manufacturer C (instead of the Carrier B), and a locatedAt attribute of the Component X may refer to a Factory O (instead of the Container N). In some embodiments, these changes may reflect the Carrier B delivering the Component X to the Manufacturer C, and unloading the Component X from the Container N to the Factory O.

In some embodiments, a process similar to the illustrative process 800 in the example of FIG. 8 may be performed between the Carrier B and the Manufacturer C in the example of FIGS. 7B-C to evidence a custody transfer and/or a location change of the Component X.

For instance, when the Carrier B arrives at the Factory O to deliver a shipment including the Component X, the Carrier B may, at an act that is similar to act 805 in the example of FIG. 8, create version 3 of the inCustodyOf attribute and version 3 of the locatedAt attribute. Version 3 of the inCustodyOf attribute may store a reference to the Manufacturer C, because the Carrier B is transferring custody of the Component X to the Carrier B. Version 3 of the locatedAt attribute may store a reference to the Factory O, because the Component X is being removed from the Container N and stored at the Factory O.

In some embodiments, a data management service may check that the Carrier B is authorized to modify one or more data structures that the Carrier B is proposing to modify in the Component X's private state (e.g., the inCustodyOf attribute and the locatedAt attribute). For instance, the data management service may check whether the Carrier B is in possession of a private key of a key pair (e.g., <https://example.org/crypto #7834b0e6-2cd3-40ad-b303-b892efae54dc>) indicated in the authorization structure for the inCustodyOf attribute, for example, by providing a fresh random value to the Carrier B, requesting that the Carrier B use the private key to sign the fresh random value, and using a public key of the key pair to verify a signature returned by the Carrier B.

Additionally, or alternatively, the data management service may check, based on the authorization structure for the inCustodyOf attribute, whether a modification proposed by the Carrier B should be allowed. For instance, the data management service may determine that the Carrier B is allowed to create version 3 of the inCustodyOf attribute because the ont: canUpdate property in the authorization structure indicates that the Carrier B is authorized to update the ont: hasLatest and ont: hasPrevious properties in the inCustodyOf attribute structure. Similarly, the data management service may check, based on the authorization structure for the locatedAt attribute, whether the Carrier B should be allowed to create version 3 of the locatedAt attribute.

In some embodiments, the Carrier B may, at acts that are similar to act 810 and act 815 in the example of FIG. 8, create and publish a badge for use in evidencing a custody transfer and/or a location change of the Component X. A distributed ledger client may check that the Carrier B is authorized to do so, for example, by checking whether the Carrier B is in possession of a private key of a key pair indicated in an authorization structure referenced in the Component X's identity node (e.g., <https://example.org/authorizations #ea60e376-5724-4c00-a539-73acaf23b532>). Additionally, or alternatively, the distributed ledger client may check, based on the authorization structure, whether a modification proposed by the Carrier B should be allowed. For instance, the Carrier B may be allowed to create a badge and associated sub-graphs (e.g., badge version, badge version attestation, etc.) because an ont: canCreate property in the authorization structure indicates that the Carrier B is authorized to create new badges and sub-graphs thereof.

In some embodiments, one or more of the checks described above may be performed by a data management service in addition to, or instead of, the distributed ledger client, and/or vice versa.

In some embodiments, one or more intermediate locations may be recorded by the Carrier B while the Component X is in transit from the Warehouse M to the Factory O. For instance, the Carrier B may record a series of Global Positioning System (GPS) coordinates of a vehicle carrying the Component X: C₁, . . . , Cᵢ, Cᵢ₊₁, . . . , Cᵢ₊ⱼ, . . . . In some embodiments, one or more versions of the locatedAt attribute may be created, for example, at Cᵢ and/or Cᵢ₊ⱼ.

In some embodiments, a version of the locatedAt attribute for Cᵢ may store a sequence of intermediate locations leading to the location Cᵢ (e.g., C₁, . . . , Cᵢ). Similarly, a version of the locatedAt attribute for Cᵢ₊ⱼ may store a sequence of intermediate locations leading to the location Cᵢ₊ⱼ (e.g., Cᵢ₊₁, . . . , Cᵢ₊ⱼ).

In some embodiments, an attestation of the version of the locatedAt attribute for Cᵢ may include a hash of the sequence of immediate locations leading to the location Cᵢ. The hash may be generated, for example, using a Merkle tree. A similar hash may be generated for an attestation of the version of the locatedAt attribute for Cᵢ₊ⱼ.

FIG. 7D shows another illustrative relationship chart 700D, in accordance with some embodiments. The relationship chart 700D may be similar to the illustrative relationship chart 700C in the example of FIG. 7C, except a belongsTo attribute of the Component X may refer to the Manufacturer C (instead of the Supplier A). In some embodiments, this change may reflect the Supplier A transferring ownership of the Component X to the Manufacturer C.

In some embodiments, a process similar to the illustrative process 800 in the example of FIG. 8 may be performed between the Supplier A and the Manufacturer C in the example of FIGS. 7C-D to evidence an ownership transfer of the Component X.

In some embodiments, the Supplier A may replace the authorization structure that authorizes the Supplier A with a new authorization structure that authorizes the Manufacturer C. Below is an illustrative RDF implementation of such a new authorization structure, in accordance with some embodiments.

```
  # Authorization structure that authorizes Manufacturer C
  (private state)
  <https://example.org/authorizations#b896242f-6262-48b0-9836-
  6f26b5f0a19c>
```

| | |
|---|---|
| rdf:type | ont:Authorization ; |
| ont:creationDate | “2019-03-30T00:00:00+00:00” ; |

```
    # Manufacturer C's signer key
    ont:hasAsymmetricKey
  <https://example.org/crypto#e924cbaa-2d4a-4e5a-9303-
  125e0ee3b24c> ;
```

| | |
|---|---|
| ont:canUpdate | [ ont:hasAsymmetricKey, |

ont:hasAttribute, ont:hasBadge, ont:hasAuthorization ] ;

| | |
|---|---|
| ont:canCreate | [ ont:hasAsymmetricKey, |

ont:hasAttribute, ont:hasBadge, ont:hasAuthorization ] ;

| | |
|---|---|
| ont:canDelete | [ ont:hasAsymmetricKey, |

ont:hasAttribute, ont:hasBadge, ont:hasAuthorization ] .

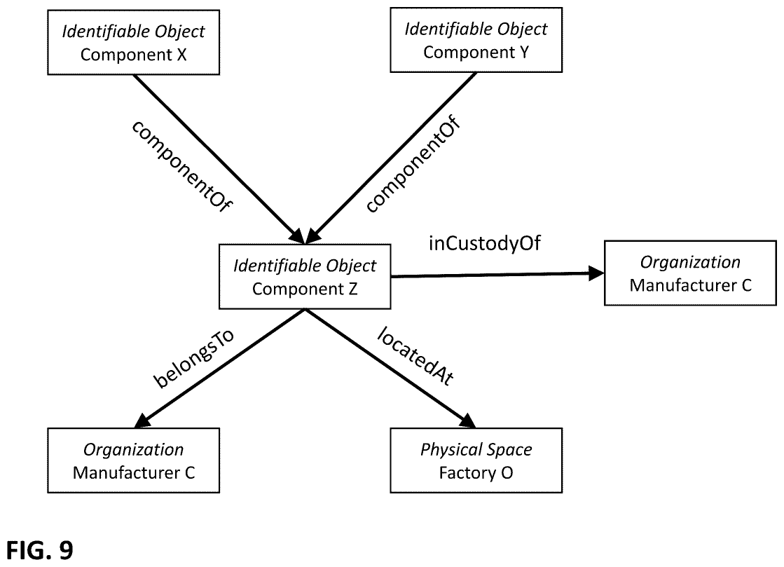

FIG. 9 shows an illustrative relationship chart 900, in accordance with some embodiments. In this example, the relationship chart 900 includes the illustrative Component X, the illustrative Manufacturer C, and the illustrative Factory O in the example of FIG. 7D, as well as illustrative Components Y and Z. The Component X may have a componentOf attribute, which may include a reference to the Component Z. Likewise, the Component Y may have a componentOf attribute, which may also include a reference to the Component Z. This may reflect the Manufacturer C assembling the Components X and Y into a system represented as the Component Z.

In some embodiments, the Component X may, by virtue of being related to the Component Z via the componentOf attribute, inherit one or more attributes of the Component Z. For instance, The Component X may have a locatedAt attribute, which may include a reference to the Factory O. This attribute may be inherited by the Component X. Additionally, or alternatively, the Component X may inherit a belongsTo attribute and/or an inCustodyOf attribute of the Component Z.

Illustrative configurations of various aspects of the present disclosure are provided below.
A1. A system comprising: at least one computer processor; and at least one computer-readable storage medium having stored thereon instructions which, when executed, program the at least one computer processor to: access information from a knowledge structure associated with an entity, wherein the knowledge structure stores both private information of the entity and state information of a distributed ledger.
A2. The system of configuration A1, wherein: the at least one computer processor is programmed to access the information from the knowledge structure at least in part by: issuing a common query to access at least a first data item from the private information of the entity and a second data item from the state information of the distributed ledger.
A3. The system of configuration A2, wherein: the common query comprises a federated query.
A4. The system of configuration A1, wherein: the private information of the entity is stored in a first data store; the state information of the distributed ledger is stored in a second data store; and the private information of the entity and the state information of the distributed ledger are accessible via a common data framework.
A5. The system of configuration A4, wherein: the first data store and the second data store are physically separate.
A6. The system of configuration A1, wherein: the accessed information comprises a view of the knowledge structure; and the at least one computer processor is programmed to access the information from the knowledge structure at least in part by: manipulating the knowledge structure to generate the view.
A7. The system of configuration A6, wherein: manipulating the knowledge structure comprises applying a view specification to the knowledge structure.
A8. The system of configuration A7, wherein: the entity comprises a first entity; the at least one computer processor is programmed to access the information from the knowledge structure in response to a request received from a second entity different from the first entity; and the view specification is provided by the second entity.
A9. The system of configuration A7, wherein: the view specification comprises a query written in a semantic query language.
B1. A system comprising: at least one computer processor; and at least one computer-readable storage medium having stored thereon instructions which, when executed, program the at least one computer processor to: access information from a knowledge structure associated with an entity, wherein: the knowledge structure comprises an identity structure for the entity; the knowledge structure further comprises an attribute structure corresponding to an attribute of the entity; the identity structure stores a pointer to the attribute structure; and the attribute structure associates a value with the attribute of the entity.
B2. The system of configuration B1, wherein: the attribute structure stores one or more data items according to a class definition in an ontology.
B3. The system of configuration B1, wherein: the attribute structure stores a pointer to an attribute version structure; and the attribute version structure stores the value associated with the attribute of the entity.
B4. The system of configuration B3, wherein: the attribute version structure stores a pointer to an attestation structure; and the attestation structure comprises a cryptographic proof generated based on the value associated with the attribute of the entity.
B5. The system of configuration B4, wherein: the attestation structure further comprises:

a signature generated based on the cryptographic proof of the value associated with the attribute of the entity; and a pointer to a key structure, the key structure storing a cryptographic key for use in verifying the signature.
C1. A system comprising: at least one computer processor; and at least one computer-readable storage medium having stored thereon instructions which, when executed, program the at least one computer processor to: access information from a knowledge structure associated with an entity, wherein: the knowledge structure comprises an identity structure for the entity; the knowledge structure further comprises a badge structure; the identity structure stores a pointer to the badge structure; the badge structure stores a pointer to a badge version structure; the badge version structure stores a pointer to an attestation structure; and the attestation structure comprises a cryptographic proof generated based on the badge version structure.
C2. The system of configuration C1, wherein: the attestation structure comprises a first attestation structure; the badge version structure further stores a pointer to an attribute version structure corresponding to an attribute of the entity; the attribute version structure associates a value with the attribute of the entity; and the attribute version comprises a pointer to a second attestation structure, the second attestation structure storing a cryptographic proof generated based on the value associated with the attribute.
C3. The system of configuration C1, wherein: the entity comprises an identifiable object; and the value associated with the attribute of the entity indicates an entity that has custody of the identifiable object.
C4. The system of configuration C1, wherein: the entity comprises an identifiable object; and the value associated with the attribute of the entity indicates an entity that has ownership of the identifiable object.
C5. The system of configuration C1, wherein: the entity comprises an identifiable object; and the value associated with the attribute of the entity indicates an entity that has custody of the identifiable object.
C6. The system of configuration C1, wherein: the entity comprises an identifiable object; and the value associated with the attribute of the entity indicates a location of the identifiable object.
C7. The system of configuration C1, wherein: the badge version structure comprises information that indicates one or more steps taken by a trusted entity to verify at least one attribute value associated with the badge version.
C8. The system of configuration C1, wherein: the badge version structure comprises private metadata of a trusted entity responsible for verifying at least one attribute value associated with the badge version.
C9. The system of configuration C1, wherein: the badge version structure comprises information that indicates a state of the badge version.
D1. A system comprising: at least one computer processor; and at least one computer-readable storage medium having stored thereon instructions which, when executed, program the at least one computer processor to: receive a proposed transaction for a distributed ledger, the proposed transaction comprises a change in a state of the distributed ledger; determine whether to accept the transaction, at least in part by determining whether an entity that has signed the proposed transaction is authorized to make the change in the state of the distributed ledger; and in response to determining that the transaction is to be accepted, generate a query for updating a knowledge structure to reflect the change in the state of the distributed ledger.
D2. The system of configuration D1, wherein: the entity that has signed the proposed transaction comprises a first entity; and the change in the state of the distributed ledger comprises creation of a badge version for a second entity different from the first entity.
D3. The system of configuration D2, wherein: the knowledge structure comprises a badge for the second entity; the badge comprises authorization information; determining whether the first entity is authorized to make the change in the state of the distributed ledger comprises checking the authorization information of the badge to determine if the first entity is authorized to create a badge version for the second entity.
D4. The system of configuration D3, wherein: the badge stores a pointer to a data structure storing the authorization information.
D5. The system of configuration D3, wherein: the authorization information comprises information indicating one or more cryptographic keys.
E1. A method performed by the system of any of configurations A1-A9, B1-B5, C₁-C8, and D1-D5.
F1. The at least one computer-readable storage medium of any of configurations A1-A9, B1-B5, C₁-C8, and D1-D5.

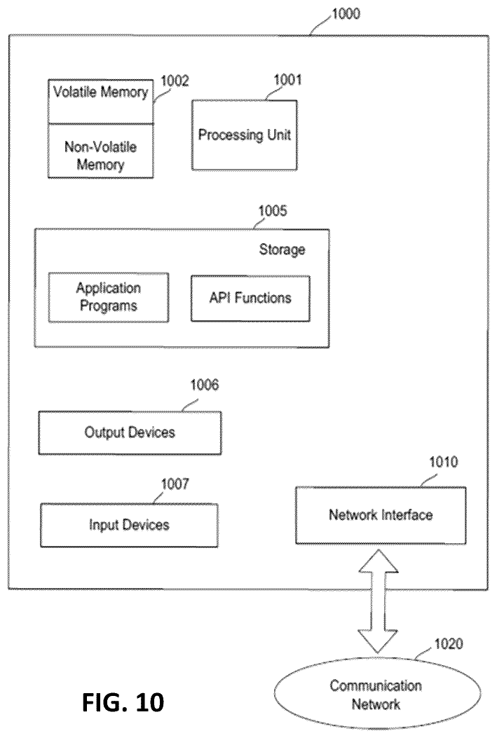

FIG. 10 shows, schematically, an illustrative computer 1000 on which any aspect of the present disclosure may be implemented.

In the example shown in FIG. 10, the computer 1000 includes a processing unit 1001 having one or more processors and a non-transitory computer-readable storage medium 1002 that may include, for example, volatile and/or non-volatile memory. The memory 1002 may store one or more instructions to program the processing unit 1101 to perform any of the functions described herein. The computer 1000 may also include other types of non-transitory computer-readable medium, such as storage 1005 (e.g., one or more disk drives) in addition to the system memory 1002. The storage 1005 may also store one or more application programs and/or resources used by application programs (e.g., software libraries), which may be loaded into the memory 1002.

The computer 1000 may have one or more input devices and/or output devices, such as devices 1006 and 1007 illustrated in FIG. 10. These devices may be used, for instance, to present a user interface. Examples of output devices that may be used to provide a user interface include printers and display screens for visual presentation of output, and speakers and other sound generating devices for audible presentation of output. Examples of input devices that may be used for a user interface include keyboards and pointing devices (e.g., mice, touch pads, and digitizing tablets). As another example, the input devices 1007 may include a microphone for capturing audio signals, and the output devices 1006 may include a display screen for visually rendering, and/or a speaker for audibly rendering, recognized text.

In the example shown in FIG. 10, the computer 1000 also includes one or more network interfaces (e.g., the network interface 1010) to enable communication via various networks (e.g., the network 1020). Examples of networks include a local area network (e.g., an enterprise network) and a wide area network (e.g., the Internet). Such networks may be based on any suitable technology and operate according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more processors, perform methods that implement the various embodiments of the present disclosure discussed above. The computer-readable medium or media may be transportable, such that the program or programs stored thereon may be loaded onto one or more different computers or other processors to implement various aspects of the present disclosure as discussed above.

The terms “program” or “software” are used herein to refer to any type of computer code or set of computer-executable instructions that may be employed to program one or more processors to implement various aspects of the present disclosure as discussed above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey relationship between the fields. However, any suitable mechanism may be used to establish a relationship between information in fields of a data structure, including through the use of pointers, tags, or other mechanisms that establish relationship between data elements.

Various features and aspects of the present disclosure may be used alone, in any combination of two or more, or in a variety of arrangements not specifically discussed in the embodiments described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

1-30. (canceled)

31. A system comprising:
at least one computer processor; and
at least one computer-readable storage medium having stored thereon instructions which, when executed, program the at least one computer processor to:
receive a proposed transaction for a distributed ledger, wherein:
the distributed ledger stores at least one data structure associated with an entity;
the at least one data structure stored on the distributed ledger comprises a reference to a first version of an attribute of the entity;
the proposed transaction comprises a reference to a second version of the attribute of the entity; and
the proposed transaction further comprises at least one cryptographic proof associated with the second version of the attribute of the entity;
determine whether the proposed transaction is to be accepted, at least in part by checking the at least one cryptographic proof associated with the second version of the attribute of the entity; and
in response to determining that the proposed transaction is to be accepted, effectuate a state change of the distributed ledger, wherein the state change comprises replacing the reference to the first version of the attribute of the entity with the reference to the second version of the attribute of the entity.

32. The system of claim 31, wherein:
the state change of the distributed ledger further comprises storing the at least one cryptographic proof associated with the second version of the attribute of the entity on the distributed ledger.

33. The system of claim 32, wherein the second version of the attribute of the entity is not stored on the distributed ledger.

34. The system of claim 31, wherein:
the entity comprises a first entity;
the proposed transaction comprises a signature generated by a second entity;
the at least one computer processor is further programmed to determine whether the second entity is authorized to update the at least one data structure; and
the at least one computer processor is programmed to reject the proposed transaction in response to determining that the second entity is not authorized to update the at least one data structure.

35. The system of claim 34, wherein the second entity is different from the first entity.

36. The system of claim 34, wherein the at least one computer processor is programmed to determine whether the second entity is authorized to update the at least one data structure at least in part by:
using an authorization structure associated with the first entity to determine a public key; and
using the public key to verify the signature generated by the second entity.

37. The system of claim 36, wherein the at least one computer processor is programmed to determine whether the second entity is authorized to update the at least one data structure further by:
using the authorization structure associated with the first entity to determine whether the second entity is authorized to update the at least one data structure with the reference to the second version of the attribute of the first entity.

38. A computer-implemented method comprising acts of:
receiving a proposed transaction for a distributed ledger, wherein:
the distributed ledger stores at least one data structure associated with an entity;
the at least one data structure stored on the distributed ledger comprises a reference to a first version of an attribute of the entity;
the proposed transaction comprises a reference to a second version of the attribute of the entity; and
the proposed transaction further comprises at least one cryptographic proof associated with the second version of the attribute of the entity;
determining whether the proposed transaction is to be accepted, at least in part by checking the at least one cryptographic proof associated with the second version of the attribute of the entity; and
in response to determining that the proposed transaction is to be accepted, effectuating a state change of the distributed ledger, wherein the state change comprises replacing the reference to the first version of the attribute of the entity with the reference to the second version of the attribute of the entity.

39. The computer-implemented method of claim 38, wherein the state change of the distributed ledger further comprises storing the at least one cryptographic proof associated with the second version of the attribute of the entity on the distributed ledger.

40. The computer-implemented method of claim 39, wherein the second version of the attribute of the entity is not stored on the distributed ledger.

41. The computer-implemented method of claim 38, wherein:
the entity comprises a first entity;
the proposed transaction comprises a signature generated by a second entity;
the computer-implemented method further comprises an act of determining whether the second entity is authorized to update the at least one data structure; and
the proposed transaction is rejected in response to determining that the second entity is not authorized to update the at least one data structure.

42. The computer-implemented method of claim 41, wherein the second entity is different from the first entity.

43. The computer-implemented method of claim 41, wherein the act of determining whether the second entity is authorized to update the at least one data structure comprises:
using an authorization structure associated with the first entity to determine a public key; and
using the public key to verify the signature generated by the second entity.

44. The computer-implemented method of claim 43, wherein the act of determining whether the second entity is authorized to update the at least one data structure further comprises:
using the authorization structure associated with the first entity to determine whether the second entity is authorized to update the at least one data structure with the reference to the second version of the attribute of the first entity.

45. At least one computer-readable storage medium having stored thereon instructions which, when executed, program at least one computer processor to perform a method comprising acts of:
receiving a proposed transaction for a distributed ledger, wherein:
the distributed ledger stores at least one data structure associated with an entity;
the at least one data structure stored on the distributed ledger comprises a reference to a first version of an attribute of the entity;
the proposed transaction comprises a reference to a second version of the attribute of the entity; and
the proposed transaction further comprises at least one cryptographic proof associated with the second version of the attribute of the entity;
determining whether the proposed transaction is to be accepted, at least in part by checking the at least one cryptographic proof associated with the second version of the attribute of the entity; and
in response to determining that the proposed transaction is to be accepted, effectuating a state change of the distributed ledger, wherein the state change comprises replacing the reference to the first version of the attribute of the entity with the reference to the second version of the attribute of the entity.

46. The at least one computer-readable storage medium of claim 45, wherein:
the state change of the distributed ledger further comprises storing the at least one cryptographic proof associated with the second version of the attribute of the entity on the distributed ledger.

47. The at least one computer-readable storage medium of claim 46, wherein:
the second version of the attribute of the entity is not stored on the distributed ledger.

48. The at least one computer-readable storage medium of claim 45, wherein:
the entity comprises a first entity;
the proposed transaction comprises a signature generated by a second entity;
the method further comprises an act of determining whether the second entity is authorized to update the at least one data structure; and
the proposed transaction is rejected in response to determining that the second entity is not authorized to update the at least one data structure.

49. The at least one computer-readable storage medium of claim 48, wherein the second entity is different from the first entity.

50. The at least one computer-readable storage medium of claim 48, wherein the act of determining whether the second entity is authorized to update the at least one data structure comprises:
using an authorization structure associated with the first entity to determine a public key; and
using the public key to verify the signature generated by the second entity.

51. The at least one computer-readable storage medium of claim 50, wherein the act of determining whether the second entity is authorized to update the at least one data structure further comprises:
using the authorization structure associated with the first entity to determine whether the second entity is authorized to update the at least one data structure with the reference to the second version of the attribute of the first entity.
